(19) United States
(12) Patent Application Publication
(10) Pub. No.: US 2026/0032567 A1
(43) Pub. Date: Jan. 29, 2026

(54) SYSTEMS, DEVICES AND METHODS FOR VEHICLE WIRELESS DATA TRANSMISSION, INCLUDING TIRE PRESSURE MONITORING

(71) Applicant: Cypress Semiconductor Corporation, San Jose, CA (US)

(72) Inventors: Thomas LEMENSE, Farmington, MI (US); Kameswara MEDAPALLI, Saratoga, CA (US); Ajinder Pal SINGH, Allen, TX (US); Victor ZHODZISHSKY, Potomac, MD (US); Oleksandr KARPIN, Lviv (UA)

(73) Assignee: Cypress Semiconductor Corporation, San Jose, CA (US)

(21) Appl. No.: 19/282,912

(22) Filed: Jul. 28, 2025

Related U.S. Application Data
(60) Provisional application No. 63/676,876, filed on Jul. 29, 2024.
(60) Provisional application No. 63/685,254, filed on Aug. 20, 2024.

(51) Int. Cl. H04W 48/16; H04W 4/38; H04W 4/40; H04W 4/80; H04W 48/10

(52) U.S. Cl. CPC H04W 48/16; H04W 4/38; H04W 4/40; H04W 4/80; H04W 48/10

(57) ABSTRACT

A method can include a tire pressure monitoring system (TPMS) sensor that can operate in an asynchronous mode that includes wirelessly transmitting TPMS data advertisements (ADVs), and switch to a synchronous mode that can include ceasing transmission of the TPMS data ADVs, entering a low power state in which the TPMS sensor does not wirelessly transmit or receive, and in response to a request message from a TPMS central device, selectively transmit a TPMS response in a time slot of a repeating advertising interval. TPMS data ADVs and a TPMS response can include tire state data and be compatible with at least one BT standard. Corresponding devices and systems are also disclosed.

### CROSS-REFERENCE TO RELATED APPLICATIONS

The present application claims the priority and benefit of U.S. Patent Application No. 63/676,876 filed on Jul. 29, 2024, and U.S. Patent Application No. 63/685,254 filed on Aug. 20, 2024, the contents of which are incorporated by reference herein in their entirety.

### TECHNICAL FIELD

The present disclosure relates generally to vehicle wireless systems, more particularly to vehicle wireless systems that transmit and receive data from multiple sources such as tire pressure monitoring sensors.

### BACKGROUND

Conventional Tire Pressure Monitoring Systems (TPMSs) can operate at sub-GHz frequencies. In such systems, each tire can contain a non-replaceable, battery-powered sensor unit equipped with a pressure sensor, a motion/acceleration sensor, and a sub-GHz radio transmitter (typically transmitting 315 or 434 MHz). Such a conventional sensor unit can react to pressure or motion stimulus, and change its behavior accordingly. Data can be transmitted by the sensor unit to a central unit of a vehicle. Such data is sent via a one-way RF link that can result redundant copies being sent (typically 30-50× more than necessary). Such conventional sensors are unaware of each other, transmitting only according to their own state, and so RF ‘collisions’ are possible (i.e., different sensor units transmitting to the central unit at the same time).

In another conventional TPMS system, tire state data is transmitted according to the Bluetooth Low Energy Standard (BLE). Based on their own individual timing criteria, each tire sensor unit can transmit advertisements on BLE channels (e.g., 2.402 GHz to 2.48 GHz) that include tire data. As in the case of a sub-GHz system, sensor unit transmissions can be redundant and/or subject to collision.

It would be desirable to arrive at some way providing wireless data communications that does not suffer from the drawbacks of conventional approaches.

### SUMMARY

A method can include, by operation of at least one tire pressure monitoring system (TPMS) sensor, operating in an asynchronous (async) mode that includes wirelessly transmitting TPMS data via BLE “advertisements” (ADVs). A TPMS central device may detect the ADVs from the TPMS sensor, and in response, transmit a response which may include a request to use a synchronous mode of communication. In response to receiving a synchronous request from a TPMS central device, a TPMS sensor can switch to a synchronous mode. If a response is not received, a TPMS sensor may continue to operate in an async mode. In a synchronous mode, async transmission of the TPMS data ADVs can cease, and the sensor can enter a low power state in which it may only communicates with the TPMS central during negotiated time slots in a repeating advertising interval. During these time slots, the sensor can leave a lower power state, and in response to a request message from a TPMS central device, a TPMS response can be transmitted the time slot and then the low power state can be re-entered. TPMS data ADVs and a TPMS response can include tire state data and be compatible with at least one BT standard.

### BRIEF DESCRIPTION OF DRAWINGS

FIG. 1 is a diagram of a vehicle system according to an embodiment.

FIG. 2-0 is a timing diagram showing operations of a conventional tire pressure monitoring system (TPMS) sensor. FIG. 2-1 is a timing diagram showing operations of a TPMS sensor according to an embodiment.

FIG. 3 is a timing diagram showing operations of a Central Unit and TPMS sensor unit according to an embodiment.

FIG. 4 is a timing diagram showing conventional operations of a Central Unit and TPMS sensor unit.

FIG. 5 is a timing diagram showing tire sensing and reporting operations according to an embodiment.

FIG. 6 is a timing diagram showing operations of a vehicle system according to an embodiment.

FIG. 7 is a block diagram of a TPMS sensor unit according to an embodiment.

FIG. 8 is a block diagram of a TPMS sensor unit according to another embodiment.

FIG. 9 is state diagram of TPMS sensor unit operations according to an embodiment.

FIG. 10 is a block diagram of TPMS Sensor circuits according to an embodiment.

FIGS. 11-0 and 11-1 are diagrams showing a TPMS sensor unit according to an embodiment.

FIGS. 12-0, 12-1 and 12-2 are timing diagrams showing operations of vehicle systems according to embodiments.

FIG. 13 is a block diagram of a vehicle system according to an embodiment.

FIG. 14 is a block diagram of a Central Unit according to an embodiment.

FIG. 15 is a diagram showing vehicle system operations according to another embodiment.

FIG. 16 is a block diagram of Central Unit circuits according to an embodiment.

FIG. 17 is a diagram of a Central Unit circuits according to an embodiment.

FIG. 18 is a diagram of a vehicle system according to another embodiment.

FIGS. 19-0 and 19-1 are timing diagrams showing operations of a Central Unit according to embodiments.

FIG. 20 is a diagram showing conventional channel usage of a Bluetooth (BT) device.

FIGS. 21-0 and 21-1 are diagrams showing channel usage of a BT TPMS sensor unit according to an embodiment.

### DETAILED DESCRIPTION

According to embodiments, a vehicle system can include Tire Pressure Monitoring System (TPMS) sensor units. Energy consumed by TPMS sensor units can be greatly reduced as compared to conventional approaches, thereby prolonging their battery life. TPMS sensor unit activity, including wireless transmission, can be synchronized across all TPMS sensor units, this can reduce if not eliminate the possibility of radio frequency (RF) collision, as well as provide more precise control of TPMS sensor unit operating states.

According to embodiments, one or more Central Units of a vehicle system can synchronize TPMS sensor unit activity. A Central Unit can collect, manage, distribute, analyze, etc. tire state data supplied by TPMS sensor units. Embodiments can include a vehicle system architecture in which a communication schemes between Central Unit(s) and the TPMS sensor units can enable Central Unit hardware and bandwidth to also support other wireless function, including but not limited to car access functions (e.g., “Phone as a Key”, key fob units, etc.).

According to embodiments, a TPMS sensor unit can transition between multiple modes, including an asynchronous mode and a synchronous mode. In an asynchronous mode, TPMS sensor units can essentially operate independently of other TPMS sensor units, transmitting tire state data periodically. In response to tire state data detected by a TPMS sensor unit and/or a transmission from a Central Unit, a TPMS sensor unit can transition from an asynchronous mode a synchronous mode. In a synchronous mode, a TPMS sensor unit can enter a low power sleep state that consumes very little power, then wake at a predetermined time slot to transmit tire state data to a Central Unit. Each TPMS sensor unit can have a different time slot. Sleep intervals can conserve TPMS sensor unit power. Different assigned time slots can ensure collisions do not occur, as well as enable greater bandwidth for Central Unit(s) to execute wireless operations with other devices (e.g., scan for keyless entry, connect to user devices, etc.).

In some embodiments, TPMS sensor units can transmit according to one or more Bluetooth (BT) standards, including BT Low Energy (BLE). In an asynchronous mode, TPMS sensors can transmit tire state data in connectable advertisements (ADVs). TPMS sensor units can transition from an asynchronous mode to a synchronous mode in response to receiving a Sync Transfer Packet from a Central Unit that includes synchronization information (sync info). In a synchronous mode, a TPMS sensor unit can enter a deep sleep mode in which it may not transmit or receive. According to sync info, the TPMS sensor unit can awake to receive a Periodic Advertising with Response (PAwR) ADV from a Central Unit, and in response, return a response message that includes tire state data.

According to embodiments, TPMS sensor units can conditionally transmit tire state data. If tire state data has not changed since a previous response, no response can be returned. If tire state has changed, a response message can be transmitted. Such an arrangement can eliminate or greatly reduce the transmission of redundant data.

In some embodiments, upon detecting asynchronous TPMS sensor units, a Central Unit can initiate an authentication operation with the TPMS sensor units. Subsequent transmissions of tire state data by TPMS sensor units, in the asynchronous and/or synchronous mode, can be encrypted.

In some embodiments, a TPMS sensor unit can transition to a high rate mode from either an asynchronous or synchronous mode. In a high rate mode, a TPMS sensor can transmit tire state data at a faster rate than an asynchronous or synchronous mode. A high rate mode can be triggered in response to any suitable condition, including but not limited to an alarm state, changes in tire state and/or a tire filling operation.

According to embodiments, a Central Unit can be used for both TPMS and car access functions. TPMS communication can be synchronized and coordinated by the Central Unit. For synchronized communication, PAwR can be used, with a Central Unit operating as the single coordinator for both functions (i.e., TPMS and car access). As noted herein, PAwR can be used after a TPMS sensor unit has come out of “deep sleep” by observing pressure or motion stimulus. Initially, a TPMS sensor unit can transition from the deep sleep mode to an asynchronous mode and begin BLE advertising to communicate with a Central Unit. A Central Until can then transition communications with a TPMS sensor unit by initiating PAwR. Once PAwR has started, a TPMS sensor unit may no longer react only to observed pressure and motion stimulus, but can wait for advertisements from a Central Unit and then responds at specified times (e.g., a PAwR “subevent”).

FIG. 1 is a diagram of a vehicle system 100 according to an embodiment. A vehicle system 100 can include a first central unit 102-0, second central unit 102-1 and TPMS sensors 104-0 to 104-3. Also shown is a user wireless device 106 that can execute one or more vehicle related applications (e.g., digital key) 108. First and second central units (102-0, -1) can serve to communicate with other portions of system 100. In the embodiment shown, a central unit (102-0, -1) can communicate according to multiple wireless protocols, including BLE and ultra-wide-band (UWB). Central units (102-0, -1) can also include a secure element (SE) that isolate data and/or applications from attacks.

TPMS sensor units (104-0 to -3) can be mounted within tires and wirelessly transmit tire state data to one or both of Central Units (102-0, -1). According to embodiments, TPMS sensor units (104-0 to -3) can have various modes, including an asynchronous (async) mode and a synchronous mode. In an async mode, each TPMS sensor unit (104-0 to -3) can transmit tire state data periodically according to its own state, regardless of the state or transmissions of other TPMS sensor units. In a synchronous mode, each TPMS sensor unit (104-0 to -3) can be assigned a different time slot within a repeating interval during which it may, or may not, transmit tire state data. In the embodiment shown, TPMS sensor units (104-0 to -3) can operate according to a BLE standard. In an async mode, TPMS sensors (104-0 to -3) can transmit connectable BLE ADVs with tire state data. In a synchronous mode, TPMS sensors (104-0 to -3) can transmit tire data in different PAwR responses to one or more Central Units (102-0, -1). Such PAwR responses can be assigned to different time slots a sub-interval of a repeating advertising interval.

In some embodiments, TPMS sensor units (104-0 to -3) can also receive and, optionally, transmit data according to another standard and different frequency range than async and synchronous TPMS data. For example, TPMS sensor units (104-0 to -3) may receive and in some embodiments transmit at a low frequency (LF) (e.g., 125 kHz) for advantageous compatibility with existing TPMS standards or protocols. In some embodiments, a LF signal or message between a Central Unit and TPMS sensor unit can be used to initially wake and configure the TPMS sensor unit.

Unlike conventional systems, a system 100 can include more than one Central Unit (in the embodiment shown, two) (102-0, -1) that can provide TPMS functions. In some embodiments, Central Units (102-0, -1) can be redundant, with each Central Unit (102-0, -1) receiving tire state data from one or more of the same TPMS sensor units (104-0 to -3) in the same time slot(s). In addition or alternatively, Central Units (102-0, -1) can distribute TPMS operations, with one Central Unit (e.g., 102-0) receiving tire state data from one or more TPMS sensors (e.g., 104-0, -1), while another Central Unit (e.g., 102-1) receives tire state data from other TPMS sensors (e.g., 104-2, -3).

According to embodiments, a Central Unit (102-0, -1) can place TPMS sensors (104-0 to -3) into a synchronous state to confine reception of tire state data, and thus free up bandwidth to service any other suitable wireless devices or services, including but not limited to a digital key application 06. In some embodiments, other wireless devices or services can be BLE devices that may or may not be synchronized with TPMS tire state data transmissions. However, embodiments include such other wireless devices/services operating according to another suitable wireless protocols (e.g., UWB, IEEE 802.11 wireless, Zigbee, etc.).

In this way, a vehicle system can include TPMS sensor units that can switch between an async mode, in which sensors transmit independently according to their own sensed state, and a synchronous mode, in which TPMS sensors can each selectively transmit tire state data in a different time slot within a repeating advertising interval. A reception and processing of tire state data from TPMS sensor operations can be distributed between two or more Central Units. A Central Unit can synchronize reception of tire state data and thus free-up bandwidth for other wireless operations for a vehicle.

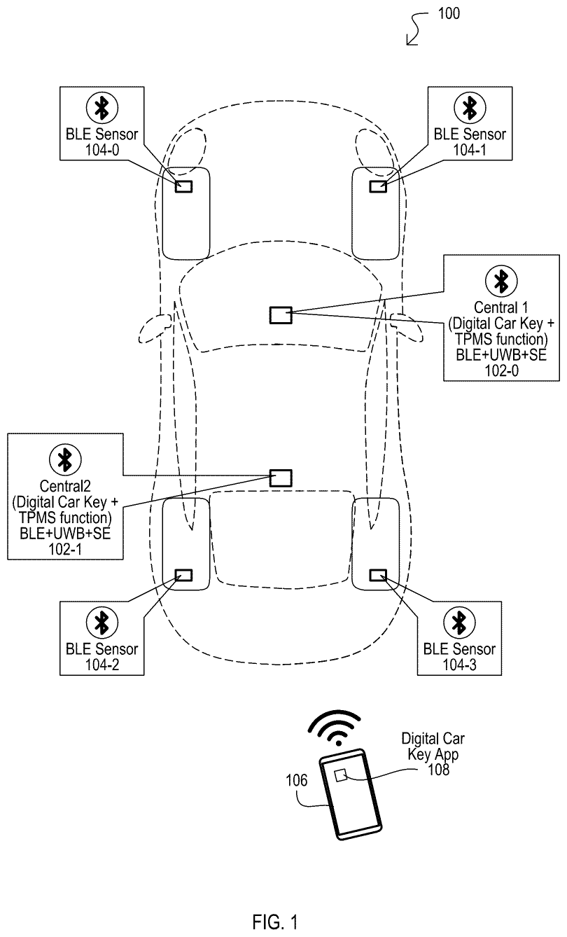

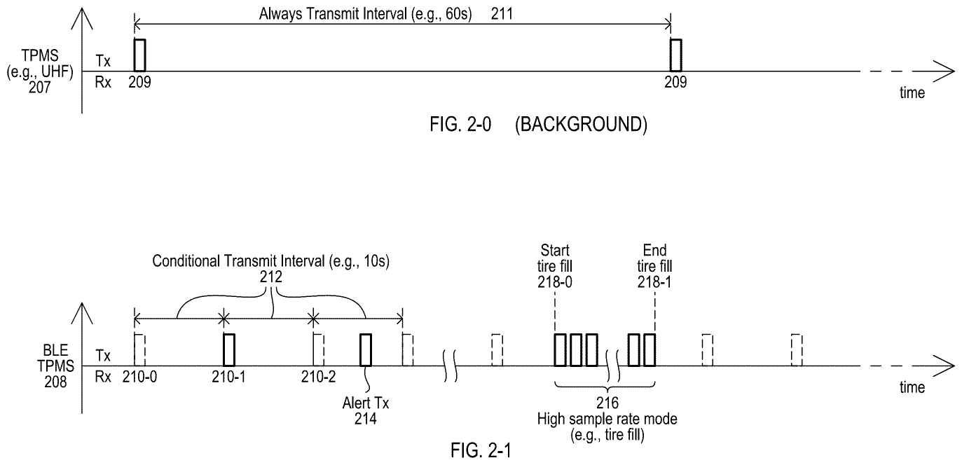

FIG. 2-0 is a timing diagram showing conventional TPMS operations. Upon power-up, and after an initial configuration, a TPMS sensor can acquire and transmit tire pressure and temperature data 209 at a fixed interval 211. Such transmissions can be ultra-high frequency (UHF) messages in the range of 314.9-433.92 MHz. A fixed interval 211 can be in the range of 30-120 seconds.

FIG. 2-1 is a timing diagram showing TPMS operations 208 according to an embodiment. A TPMS sensor can have conditional transmissions times 210-0 to 210-2 during which it may, or may not, transmit tire state data. Conditional transmission times (210-0 to -2) can be spaced at conditional transmit intervals 212, which may or may not be regular. In some embodiments, conditional transmit intervals 212 can be less than 30 seconds (30s), including about 10 s. A TPMS sensor can selectively transmit tire state data based on any suitable conditions, including changes in tire state data compared to a previous transmission. In some embodiments, such changes can include passing a limit, passing limits with hysteresis, rates of change, sensor status, or battery level. Limits can include any suitable limits for tire states, including as but not limited to, tire pressure exceeding and/or falling below one or more limits, a tire pressure increase rate and/or decrease rate exceeding a limit, or tire acceleration exceeding a limit. Tire state data can include any suitable data, including but not limited to tire pressure, tire temperature, and tire acceleration. Embodiments anticipate TPMS sensor operations that can include unconditional transmission times (210-0 to -2) intermixed with conditional transmission times.

In some embodiments, in addition to conditional transmission times, a TPMS can make unconditional transmissions (e.g., alert transmissions) 214 in response to predetermined conditions. For example, high rate drops in pressure and/or pressure below a threshold. In some embodiments, unconditional transmissions 214 can be BLE ADVs transmitted by a TPMS sensor unit. In addition or alternatively, such transmissions can be responses elicited by request transmissions from a Central Unit (e.g., PAwR).

In some embodiments, in addition to conditional transmission times, a TPMS sensor unit can include a high sample rate mode 216 in which tire state data can be transmitted at shorter time intervals than conditional time intervals 212. A high sample rate mode 216 is shown in FIG. 2-1 that includes a start time 218-0 and an end time 218-1. As in the case of unconditional transmissions 214, a high sample rate mode 216 can include a sequence of BLE ADVs and/or responses generated from a request issued by a Central Unit.

In some embodiments, a high sample rate mode 216 can correspond to a tire filling operation (i.e., “Tire Fill Assist” feature). In a conventional Tire Fill Assist feature, a TPMS sensor unit may operate by assuming that every time it stops rolling, it might get filled with air, and so it begins high rate sampling for some time. In contrast, according to embodiments, a driver can inform a vehicle that a tire filling operation is intended or started. In response, a Central Unit can increase a reporting rate for TPMS sensor units. In some embodiments, a Central Unit can change a PAwR Advertisement rate to a more frequent one, and thus support tire pressure readings in real time. A Tire Fill Assist feature can be initiated in any suitable manner, including but limited to: a user indicating an intention to fill tires via a cluster/screen of a vehicle or a user portable electronic device (e.g., smart phone, wearable device in communication with a vehicle), or a sensor state (e.g., tire pressure increase rate, physical proximity to transmitting fill state, geolocation).

In this way, TPMS sensors operations can include periodic, conditional transmission times in which a tire state data may or may not be transmitted. In addition to conditional transmissions, TPMS sensor operations can include alert transmissions in response to predetermined tire states and/or high sample rate modes that transmits tire state data at a faster rate than a conditional transmission rate.

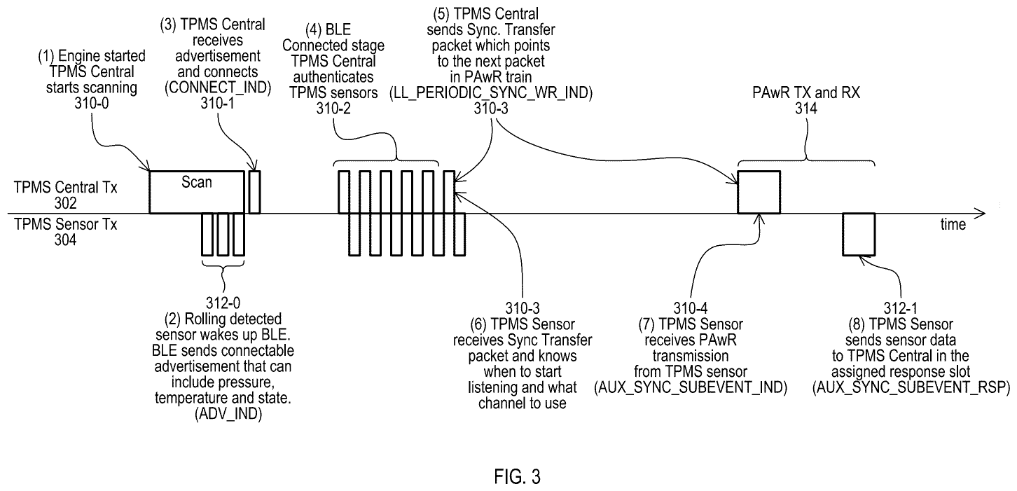

FIG. 3 is a timing diagram showing operations of a Central Unit and TPMS sensor unit that can establish a PAwR train for reporting tire state data. FIG. 3 shows BLE transmissions of a Central Unit 302 and a TPMS sensor unit 304. In the embodiment shown, upon a predetermined vehicle event (e.g., engine starting), a Central Unit can begin scanning BT frequencies 310-0 (e.g., for ADVs from TPMS sensor units). In response to a predetermined tire state (e.g., detected rolling of tire), a TPMS sensor unit can wake up BLE circuits, which can then begin transmitting connectable advertisements (e.g., ADV_IND) that can include tire pressure, temperature, and other tire state data 312-0. In some embodiments, such tire state data can be transmitted as soon as a corresponding TPMS sensor unit 304 accelerometer detects rotation.

Advertisements 312-0 transmitted by TPMS sensor unit 304 can be connectable ADVs. If a Central Unit does not connect with a TPMS sensor unit, a TPMS sensor unit can determine that an ADV has failed, and can retransmit the ADV. In some embodiments, upon a failure to connect to a Central Unit, a TPMS sensor unit can continue to transmit connectable ADVs with tire state data at predetermined intervals (e.g., 60 seconds).

A Central Unit 302 can receive connectable advertisements and connect to a TPMS sensor unit (e.g., CONNECT_IND) 310-1. Once connected, a Central Unit 302 can authenticate with TPMS sensor units 310-2. Such authentication can be according to any suitable BLE compatible authentication method.

Once authentication has been successful, a Central Unit can transmit synchronization transfer (Sync Transfer) packet, that can point to a next packet in a PAwR train (e.g., LL_PERIODIC_SYNCH_WR_IND) 310-3. A TPMS sensor unit can receive the Sync Transfer packet, and from data within such a packet, know when and on which channel(s) to start listening for an initiating PAwR transmission from a Central Unit.

According to timing established by a Central Unit (provided as sync info in the Sync Transfer packet), a Central Unit can initiate a PAwR train by transmitting a PAwR request (e.g., AUX_SYNC_SUBEVENT_IND) 310-4. Prior to such a request from a Central Unit, TPMS sensor units can awake and receive the request 310-4. From such a request, each TPMS sensor unit can transmit a response with tire state data at a different time slot following the request. FIG. 3 shows one TPMS sensor unit response 312-1 (e.g., AUX_SYNC_SUBEVENT_RSP), which can be a first of four different TPMS sensor unit responses. Such a response 312-1 can send sensor data to a Central Unit in an assigned time slot. It is understood that such a response can be conditional (e.g., transmitted if there has not been sufficient change with respect to a previous transmission).

In this way, a vehicle system Central Unit can initially scan for ADV from BT TPMS sensor units that include tire state data. A Central Unit can connect to such TPMS sensor units, authenticate them, then issue a PAwR sync info packet. In response to such a packet, TPMS sensor units can wake to receive a PAwR request, and return tire state data in different subsequent time slots.

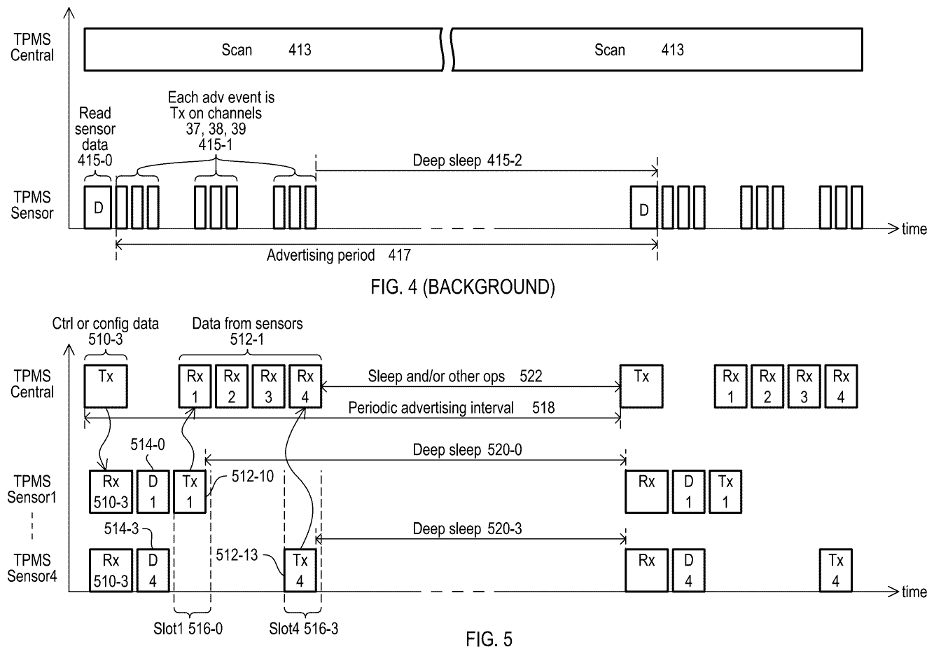

FIG. 4 is a timing diagram showing a conventional BLE tire sensing operation, including operations of a sole Central Unit (TPMS Central) and one or four TPMS sensor units (TPMS sensor). Each TPMS sensor unit can wake up independently, and then read its sensor data 415-0. During a repeating BLE advertising period 417, a TPMS sensor unit can transmit three ADV events with sensor data on dedicated BLE advertising channels 37, 38 and 39 (415-1). The conventional TPMS sensor unit can then enter a deep sleep 415-2 until a next advertising period. Advertising periods can be set to 30-60 seconds.

Because conventional TPMS sensor units operate independently, sensor data ADVs can be transmitted at any time during an advertising period. Accordingly, Central Unit must be scanning 413 one-hundred percent of the time to ensure it receives TPMS sensor data.

FIG. 5 is a timing diagram showing tire sensing and reporting operations according to an embodiment. Such operations may, or may not be according to a BLE standard. FIG. 5 shows operations of a Central Unit (TPMS Central), which may be one of multiple such units. Also shown are two of four TPMS sensor units (TPMS Sensor1, TPMS Sensor3). A Central Unit can transmit a control and/or configuration data message 510-3 that indicates a request for TPMS sensor data. In some embodiments, a control/configuration message 510-3 can include sync info for TPMS sensor units to determine a response time slot. In addition or alternatively, TPMS sensor units may already be in possession of sync info, and a control/configuration message 510-3 can be a “trigger” type message, that can elicit responses from TPMS sensor units.

In a BT (e.g., BLE) embodiment, while a control/configuration message 510-3 can be on primary advertising channels (i.e., 37, 38, 39), such a message may also advantageously be on a secondary advertising channel (e.g., 1-36).

TPMS sensor units can acquire tire state data 514-0, 514-3 (e.g., sensor data). In some embodiments, such an action can be performed in response to control/configuration message 510-3. However, in other embodiments, TPMS sensor units can have previously acquired sensor data, including in an asynchronous fashion. That is, while sensor data transmissions by TPMS sensor units can be synchronous, sensor data acquisition can be asynchronous or synchronous with sensor data transmissions.

In response to control/configuration message 510-3, each TPMS sensor unit can transmit sensor data in a response message (two shown as 512-10, 512-13) in a different time slot (516-0, 516-3). While FIG. 5 shows response messages received by a Central Unit 512-1 in a sequential order, it is understood that other TPMS sensor units can transmit response messages in other time slots, which may be between, before, or after time slots 516-0, 516-3. In some embodiments, response messages (512-10, 512-13) can be conditional, transmitted only under certain conditions (e.g., sensor data has sufficiently changed, a maximum no response time has been reached, a battery has a certain capacity). In a BT compatible embodiment, response messages can be transmitted on a secondary advertising channel (e.g., 1-36).

Referring still to FIG. 5, within a repeating periodic interval (e.g., advertising interval) 518, a Central Unit can transmit a control/configuration message 510-3 and receive response messages 512-1. A remaining part of a periodic interval 518 can be used for sleep or other operations 522. This is in contrast to a conventional approach like that of FIG. 4, in which the Central Unit may be scanning over an entire advertising interval. Each TPMS sensor unit, after transmitting a response (512-10, 512-13), can enter a deep sleep mode (520-0, 520-3). That is, for most of an advertising interval 518, TPMS sensor units can be in a deep sleep mode. In some embodiments, a deep sleep mode (520-0, 520-3) can include a TPMS sensor unit ceasing transmissions and disabling wireless receiving circuits. In some embodiments, deep sleep mode can include ceasing sensor reading operations as well.

In this way, TPMS operations can include, in a repeating interval, a Central Unit sending a control/configuration message, and in response, receiving sensor data for different TPMS sensor units in different time slots. A remaining portion of the repeating interval can be used by a Central Unit for other operations and/or a sleep mode.

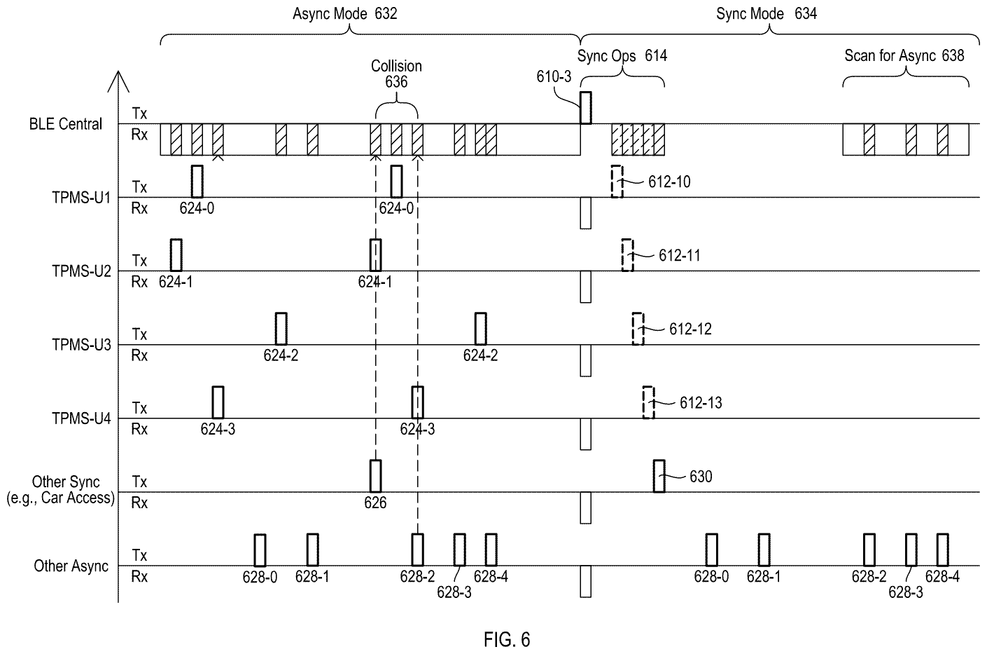

FIG. 6 is a timing diagram showing operations of a vehicle system according to another embodiment. FIG. 6 shows transmissions for a Central Unit (BLE Central), TPMS sensor units (TPMS-U1 to TPMS-U4), and a wireless system capable of being synchronized (Other Sync). In some embodiments, an Other Sync device can be a Car Access device (e.g., key fob, car as key application). FIG. 6 also shows one or more other systems that cannot be synchronized (Other Async). A vehicle system can operate in an asynchronous mode 632 and a synchronous mode 634.

In an asynchronous mode 632, TPMS-U1 to -U4 can periodically transmit connectable ADVs that include tire state data. Such ADVs (async ADV) can have timing which can be independent of one another. In some embodiments, the timing of such “async” ADVs can be based on when a TPMS sensor units was activated. Async ADVs for TPMS-U1 to -U4 are shown as 624-0, 624-1, 624-2 and 624-3, respectively. In an asynchronous mode, an Other Sync device can also operate in an asynchronous manner, sending out ADVs 626 independent of other BLE devices. Other Async devices can provide ADVs 628-0 to 628-4 at various times.

In an asynchronous mode 632, because the various wireless units devices (TPMS-U1 to -U4, Other Sync, Other Async) can be transmitting at essentially any time, BLE Central can be continually scanning (in a state to receive ADVs).

In a synchronous mode 634, TPMS-U1 to -U4 and any other BT devices capable of synchronization (i.e., Other Sync), can be synchronized with a BLE Central. Synchronous operations 614 can include BLE Central transmitting a PAwR request 610-3 that can be received by TPMS Units (TPMS U1 to -4) and Other Sync unit. In response, such units can return responses in predetermined time slots. In the example shown, TPMS-U1 to -U4 can each transmit a response with tire state data shown as 612-10 to 612-13. Other Sync unit can return a response 630. While FIG. 6 shows responses 612-10 to -13 and 630 as being consecutive, responses can occur in various other orders, or at time slots that are further part (e.g., in different sub-intervals). In some embodiments, BLE Central can then dedicate all or a portion of an advertising interval that is not used for synchronous operations to scanning for Other Async devices 638.

In this way, a system can have an asynchronous mode and a synchronous mode. In an asynchronous mode, TPMS sensor units and any other synchronous capable units can synchronize with a BLE Central Unit. A BLE Central Unit can then use all or a portion of remaining bandwidth to scan for units incapable of synchronous operations.

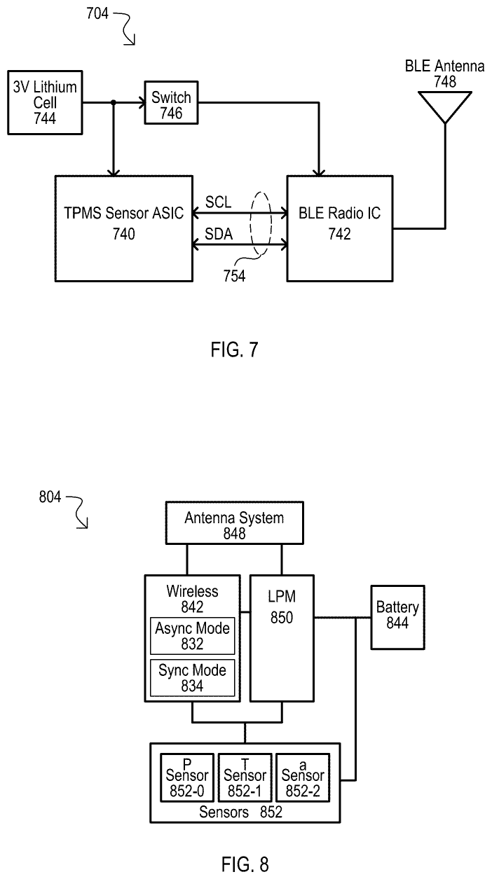

FIG. 7 is a block diagram of a TPMS sensor unit 704 according to an embodiment. A sensor unit 704 can include a TPMS Sensor integrated circuit (IC) 740, a BLE Radio IC 742, a battery 744, an antenna 748 and optionally a switch 746. A TPMS Sensor IC 740 can be an application specific IC (ASIC) that receives power from battery 744 and performs TPMS Sensor functions, including reading sensor data from TPMS sensors. A BLE radio IC 742 can execute BLE functions as described herein or equivalents, including but not limited to transmitting asynchronous connectable ADVs and configuring for synchronous operations in response to Central Unit requests. A battery 744 can provide power to a TPMS sensor unit 704, and in the embodiment shown can be a 3V Lithium cell, but this should not be construed as limiting. A switch 746 can connect power to BLE radio IC 742. In some embodiments, a switch 746 can operate according to a TPMS sensor unit mode, placing BLE radio IC 742 in a sleep mode. It is noted that a switch 746 may be a separate component, integrated into TPMS Sensor IC 740, integrated into BLE radio IC 742, or not present at all. Antenna 748 can be compatible with BLE transmissions, receiving and transmitting according to one or more BLE standards.

A TPMS sensor IC 740 and BLE radio IC 742 can communicate with one another over one or more data buses 754. Such data buses 742 can take any suitable form, and in the embodiment shown, can include an I2C compatible bus, with a serial clock line (SCL) and a serial data line (SDA).

In this way, a TPMS sensor unit can include a sensor IC that can take tire state sensor measurements, as well as a BLE compatible IC that can be placed in a sleep state by disconnecting power.

FIG. 8 is a block diagram of a TPMS sensor unit 804 according to another embodiment. A TPMS sensor unit 804 can include wireless circuits 842, a low power monitoring (LPM) circuits 850, a battery 844, sensor circuits 852 and an antenna system 848. Wireless circuits 842 can receive sensor data from sensor circuits 852 and transmit such data according to one or more wireless standards (e.g., BLE). Wireless circuits 842 can operate in an asynchronous mode 832 and synchronous mode 834. In an asynchronous mode, sensor data can be transmitted by a TPMS sensor unit 804 according to its own state (e.g., periodically). In a synchronous mode, TPMS sensor unit 804 can conditionally transmit sensor data at a predetermined time (e.g., delay, time slot) in a repeating interval (e.g., advertising interval, beacon interval, reporting interval). Such a predetermined time can be established by communications with a Central Unit.

LPM circuits 850 can include wireless circuits that can support low frequency communications with a Central Unit. In some embodiments, communications can include legacy communications at low frequency (LF) (e.g., 125 kHz). In some embodiments, such communications can be one-way, from a Central Unit to a TPMS sensor unit 804 (e.g., to wake a TPMS sensor unit). Alternatively, such communications can be two-way (e.g., wake, diagnostic, configuration). In some embodiments, LPM circuits 850 can be used to orchestrate the use of sensor circuits 852 and pass information to wireless circuits 842.

A battery 844 can provide power to various components to a TPMS sensor unit, including wireless circuits 842, LPM circuits 850 and sensor circuits 852. Sensor circuits 852 can sense various states of a tire, and in the embodiment shown can include a pressure sensor 852-0, a temperature sensor 852-1 and an acceleration sensor 852-2. In some embodiments, tire state data from sensors 852 can be provided to wireless circuits 842, and optionally, LPM circuits 850. An antenna system 848 can be connected to wireless circuits 842 and LPM circuits 850 to enable the reception and transmission of wireless messages.

In this way, a TPMS sensor unit can have wireless circuits that can operate in an asynchronous mode, in which tire state data are transmitted without regard to any other vehicle systems, and a synchronous mode in which tire state data can be transmitted at a predetermined time. A TPMS sensor unit can also include LPM circuits to accommodate legacy communications at lower frequencies.

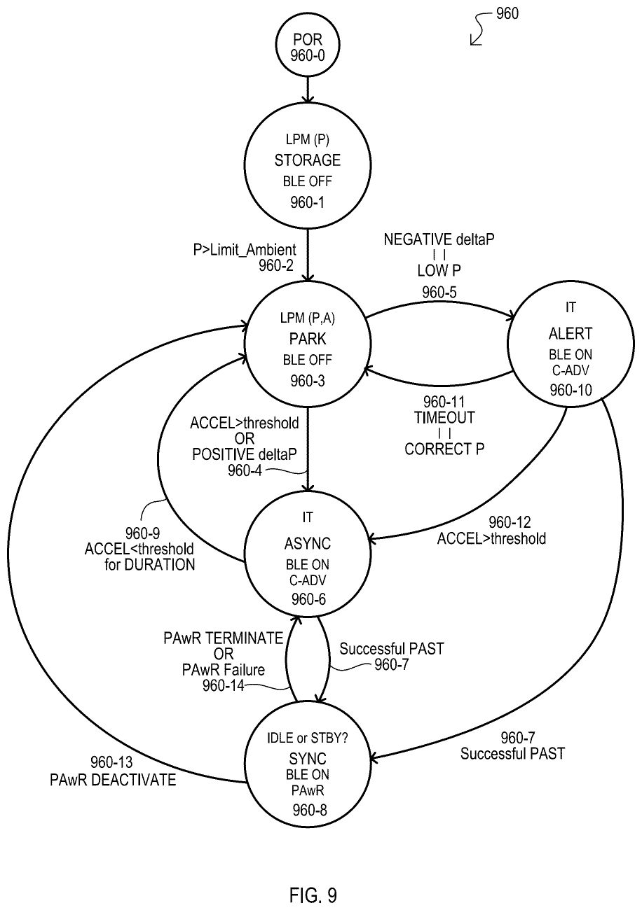

FIG. 9 is a state diagram of TPMS sensor unit operations 960 according to an embodiment. Operations 960 can be executed by processor circuits of a TPMS sensor unit. Operations 960 can begin with a TPMS sensor unit having a power-on or reset (POR) state 960-0.

From a POR state 960-0, operations can transition to a storage mode 960-1. In some embodiments, a storage mode 960-1 can correspond to a shelf mode, in which a TPMS sensor unit is stored prior to being deployed in a pressurized tire. In some embodiments, in a storage mode 960-1, a TPMS sensor unit can periodically sample pressure at long interval (e.g., minutes) using LPM circuits. If a sampled pressure is above some ambient pressure limit 960-2, operations can transition to a park mode 960-2. As but one of many possible examples, given an ambient pressure of about 100 kPa absolute (abs), a limit can be set to about 200 kPa (abs). While in storage mode 960-1, a TPMS sensor unit can respond to LF commands to enable diagnostics, testing, status check, etc. In the embodiment of FIG. 9, while in a storage mode 960-1 BLE circuits can be un-powered (BLE OFF).

In a park mode 960-3, TPMS sensor unit can periodically sample pressure and acceleration (P, A). BLE circuits can be unpowered (BLE OFF). If acceleration is above some prescribed interval (ACCEL>threshold), operations 960 can transitions to async mode 960-4 (e.g., the vehicle may be moving). If a positive pressure rate of change (i.e., slope) changes more than some prescribed amount (POSITIVE deltaP), operations 960 can also transitions to async mode 960-4 (a tire may be being filled). If a negative pressure rate of change exceeds a prescribed about (NEGATIVE deltaP) operations can transition to alert mode 960-10. Such a state can indicate a sudden loss of pressure while vehicle is parked. If a pressure is below a predetermined limit (LOW P), operations can also transition to alert mode 960-5. A low pressure threshold can be provided by a Central Unit (e.g., in LPM) and/or be a default value established by a TPMS sensor unit manufacturer. In some embodiments, in a park mode 960-3, a TPMS sensor unit can periodically sample acceleration at a first interval and pressure at a second, longer interval using LPM. In some embodiments, an acceleration threshold can be significantly more than 1 g.

In an async mode 960-6, a TPMS sensor unit can send connectable ADVs (C-ADV) for reception by Central Units. Using C-ADVs, one or more Central Units can negotiate a PaWR mode. In some embodiments, in an async mode 960-6, a TPMS sensor unit can enable BLE system/circuit (BLE ON) to issue C-ADVs that include a sensor identification (ID), temperature, pressure, and other status information. In some embodiments, C-ADVs can be transmitted about every 10 seconds. If a Central Unit and the TPMS sensor unit successfully executes a periodic advertising sync transfer PAST operation (Successful PAST) 960-7, operations 960 can transition to Sync Mode 960-8. If PAST is not successful, a TPMS sensor unit can remain in async mode 960-6 as a “fallback” mode. If the acceleration remains below a prescribed threshold for some prescribed duration (ACCEL<threshold for DURATION), the sensor can transitions to park mode 960-9. Such a state can indicate a wheel has not been rolling for a prescribed amount of time.

In a synchronous mode 960-8, a TPMS sensor unit can be engaged in PAwR with one or more Central Units. A PAwR interval can be adjusted by a Central Unit depending on conditions and needs. While PAwR intervals can be adjusted according to any suitable condition/need three conditions will be described: driving, tire localization, and tire fill assist. For a synchronous mode driving, (i.e., vehicle is moving), a TPMS sensor unit may receive PAwR requests at intervals that are relatively large (e.g., 60 s, 10 s). Further, PAwR responses provided by a TPMS sensor unit can be conditional.

For sync mode tire localization, a TPMS sensor unit can return at least tire rotation data in response to PAwR requests. Such PAwR requests can have variable intervals (e.g., “on-demand”). For example, a PAwR interval can be decreased to become much more frequent so that “time elapsed since top-dead-center” can be provided to a Central Unit for correlation with other wheel system, such as an anti-lock brake system (ABS) wheel counter.

For a sync mode tire fill assist function, a TPMS sensor unit can return real time pressure data to one or more Central Units at a relatively fast rate (e.g., 500 ms). In some embodiments, such an increase in reporting rate can be in response to a user input (e.g., a vehicle human machine interface (HMI) or application running on a user mobile device that is in communication with vehicle). When non-driving (e.g., tire localization, tire fill assist) functions are concluded, a Central Unit can return a PAwR interval to a less frequent “rolling” interval (e.g., 10 s).

In a sync mode 960-8, operations 960 can transition to park mode 960-3 in response to PAwR being deactivated 960-13. Such an action can occur when a Central Unit ends a PAwR session.

In a sync mode 960-8, operations 960 can transition to an async mode 960-6 in response to PAwR being terminated (PAwR TERMINATE) or PAwR operations failing (PAwR Failure) 960-14. PAwR TERMINATE can include a Central Unit halting a PAwR session, and requesting a TPMS sensor unit return to async mode 960-6. PAwR Failure can include a TPMS sensor unit not receiving a PAwR ADV from a Central Unit for a predetermined duration.

Referring to FIG. 9 in conjunction with FIG. 7, in an async mode 960-6, power to BLE radio IC 742 can be controlled by a TPMS Sensor IC 740. BLE radio IC 742 can be unpowered during most of an advertising interval, and then powered just prior to a desired advertising event. An async interval can be managed by a TPMS Sensor IC 740.

Referring still to FIG. 9, In an alert mode 960-10, a TPMS sensor unit can send data to Central Unit, with connectable ADV packets, at a prescribed interval. In some embodiments, such an interval can be different than that of a park mode 960-3. Connectable ADVs can include sensor ID, temperature, pressure, and other status information. According to embodiments, operations 960 can transition to a park mode 960-3 in response to exceeding a timeout period (TIMEOUT) or in response to a tire being at a correct pressure (CORRECT P) 960-11. TIMEOUT can indicate a TPMS sensor unit has attempted connection with a Central Unit are relatively short intervals (e.g., 2 s) for a preset duration (e.g., 12 hours), but no response has been received from a Central Unit. CORRECT P can indicate a tire has returned to a level above a prescribed pressure. Such a level can be provided by a Central Unit and/or be a default value established by a TPMS sensor unit manufacturer. In some embodiments, CORRECT P can include some hysteresis.

While in alert mode 960-10, in response to ACCEL>threshold, operations 960 can transition to an async mode 960-12. Such a state can indicate a tire is now rolling, and terminate an alert mode. Operations 960 can also transition to a sync mode 960-8 in the event of successful PAST 960-7. Such a state an indicate a Central Unit has successfully connected and established PAwR, and thus can terminate an alert mode.

In some embodiments, if a Central acknowledges an ADV issued in alert mode 960-10, operations can transition to a park mode 960-3.

In this way, a TPMS sensor unit can include a park mode, in which BLE circuits are off, and tire state data can be transmitted in a LPM. While a vehicle is in operation, it can transition to between an async mode in which BLE circuits transmit connectable ADVs and a synchronous mode in which tire state data is returned in response to PAwR messages from a Central Unit. A synchronous mode can include different configurations with different advertising periods and/or on-demand responses.

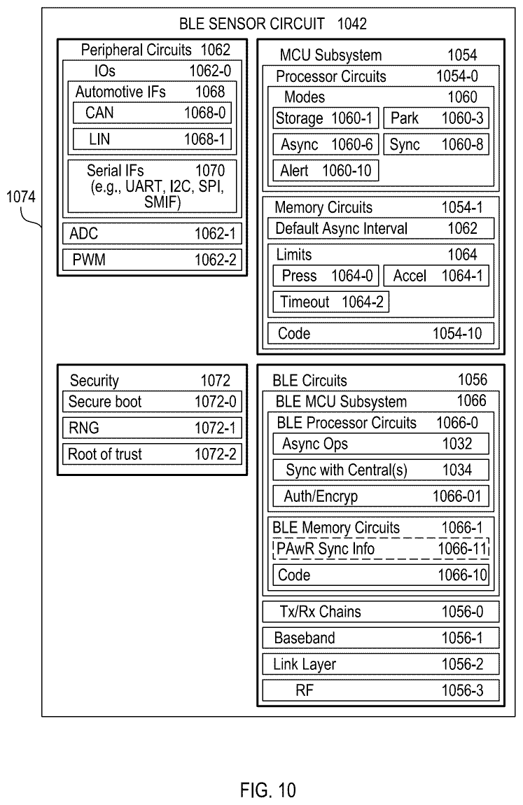

While embodiments can include TPMS operations and systems, embodiments can also include TPMS sensor units and circuits. FIG. 10 is a diagram of a BLE sensor circuit 1042 that can be included in a TPMS sensor unit according to an embodiment. A BLE sensor circuit 1042 can include a microcontroller unit (MCU) subsystem 1054, BLE circuits 1056, peripheral circuits 1062, and security circuits 1072. MCU subsystem 1054 can include processor circuits 1054-0 and memory circuits 1054-1. Processor circuits 1054-0 can take any suitable form for executing TPMS sensor operations as described herein, including but not limited to, one or more processing circuits, custom logic, programmable logic, and combinations thereof. Processor circuits 1054-0 can have modes of operation 1060, including a storage mode 1060-1, a park mode 1060-3, an async mode 1060-6, a synchronous mode 1060-8, and an alert mode 1060-10, as described herein and equivalents. According to such modes 1060, BLE sensor circuit 1042 can switch between various TPMS sensing configurations, including asynchronous ADV transmissions and synchronous (e.g., PAwR) responses that provide tire state data.

Memory circuits 1054-1 can include any suitable memory circuits, including nonvolatile memory, volatile memory or combinations thereof. Memory circuits 1054-1 can include a default async interval data 1062, limit values 1064, and code 1054-10. Async interval data can be provided to wireless circuits 1056 to establish an asynchronous ADV interval. Limits 1064 can include limits utilized to establish transition between different modes. Limits 1064 can include, but are not limited to, pressure limits 1064-0 (e.g., ambient limits, positive/negative change rates, low limits, hysteresis), acceleration limits 1064-1 (e.g., thresholds, durations), and timeout limits 1064-2 (alert timeout, time limits for a PAwR failure). It is understood that various limits can have default values provided my manufacturer, which can then be updated. Code 1054-10 can be executed by processor subsystem 1054-0 to provide the various operations noted herein.

BLE circuits 1056 can provide wireless communications according to at least one BT standard, including BLE. BLE circuits 1056 can include a BLE MCU subsystem 1066, and include transmit/receive (Tx/Rx) chains 1056-0, baseband circuits 1056-1, link layer circuits 1056-2, and radio frequency (RF) circuits 1056-3. BLE MCU subsystem 1066 can include BLE processor circuits 1066-0 and BLE memory circuits 1066-1. BLE processor circuits 1066-0 can execute async operations 1032 and synchronous operations 1034 as described herein, and equivalents. Async operations 1032 can use values provided by MCU subsystem 1054, such as a default async interval 1062. Synchronous operations 1034 can include receiving PAwR requests, and providing PAwR responses with tire state data in time slots indicated by PAwR sync info. BLE processor circuits 1066-0 can also provide authentication and encryption operations 1066-01, which can authenticate a corresponding TPMS sensor unit to a Central Unit and encrypting subsequent PAwR responses.

BLE memory circuits 1066-1 can take any suitable form as described herein, and can store data for providing the various BLE operations. Such data can include PAwR sync info 1066-11, which can have been received from a Central Unit. Code 1066-10 can be executed by BLE processor circuits 1066-0 to provide the indicated operations.

Tx/Rx chains 1056-0 can link data for transmission in BLE data frames, as well as data from received BLE frames. Baseband circuits 1056-1 can provide processing at a baseband frequency for generating data frames. Link layer processing 1056-2 can create and maintain BLE connections (e.g., to a Central Unit). RF circuits 1056-3 can include circuits for transmitting and receiving BLE frames at RF frequencies.

Peripheral circuits 1062 can include input/output (IO) circuits 1062-0 for enabling communications with a sensor device of a TPMS sensor unit (e.g., pressure, temperature and/or acceleration sensors). While IO circuits 1062-0 can take any suitable form, in the embodiment of FIG. 10, IO circuits 1062-0 can include automotive interfaces (IFs) 1068 and serial IFs 1070. Automotive IFs 1068 can be compatible with one or more vehicle standards, including but not limited to including but limited to control area network (CAN) related standards 1068-0, as well as local interconnect network (LIN) related standards 1068-1. Serial IFs 1070 can include, but are not limited to, interfaces compatible with a serial digital interface (SDI), universal serial bus (USB), universal asynchronous receiver transmitter (UART), I2C, or I2S. Peripheral circuits 1062 can include various other circuits, including but not limited to an analog-to-digital converter circuit (ADC) 1062-1 and pulse width modulation (PWM) circuits 1062-2.

Security circuits 1072 can provide various security related functions for a BLE sensor circuit 1042, including but not limited to, a secure boot operation 1072-0, random number generator (RNG) 1072-1, and a root of trust 1072-2, for cryptographic and related functions.

In some embodiments, MCU subsystem 1054, BLE circuits 1056, peripheral circuits 1062 and security circuits 1072 can be part of a same integrated circuit substrate or package 1074.

In this way, BLE sensor circuits of a TPMS sensor unit can include controller circuits that can include a storage mode, a park mode, an async mode, a synchronous mode and an alert mode. BLE sensor circuits can transition between modes in response to data received from IO circuits.

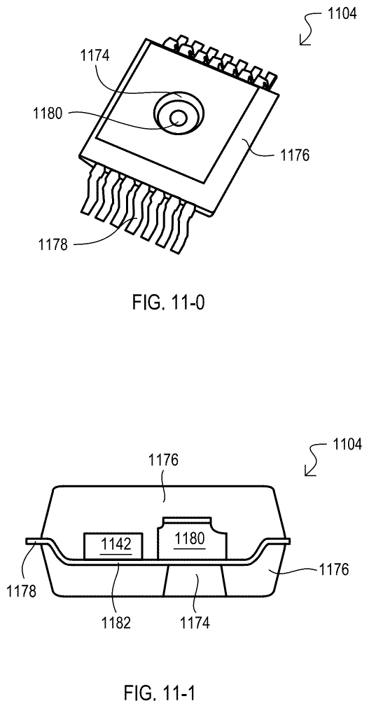

While embodiments can include TPMS sensor units and circuits with various interconnected components, embodiments can also include unitary devices capable of providing TPMS sensor unit operations that include an async and synchronous modes. In some embodiments, such unitary devices can be advantageously compact single integrated circuits (ICs). FIG. 11-0 shows a packaged IC device 1104 that can operate as a TPMS sensor unit and can include an integrated sensor. In the embodiment shown, an IC device 1104 can include conductive connections 1178, a package material 1176, and an aperture 1174 that can expose a sensor unit 1180. A sensor unit 1180 can sense pressure and other tire states, including but not limited to, temperature and/or acceleration.

FIG. 11-1 is a side cross sectional view of IC device 1104. IC device 1104 can include a sensor circuit IC 1142 and sensor unit 1180 disposed on a carrier substrate 1182, surrounded by package material 1176. Aperture 1174 can extend through package material 1176 to sensor unit 1180. Conductive connections 1178 can extend from package material 1176. In some embodiments, a sensor circuit IC can take the form of that shown in FIG. 9.

While FIGS. 11-0 and 11-1 show an IC device with an integrated sensor unit, alternate embodiments can include IC devices without sensor units.

In this way, a wireless device IC for a TPMS sensor unit that can transition between async and synchronous mode can be formed in a unitary IC package.

While embodiments can include TPMS sensor units in communication with one Central Unit, embodiments also include systems in which TPMS sensor units can provide tire state data to more than one Central Unit.

FIGS. 12-0, 12-1 and 12-3 are timing diagrams showing operations of vehicle systems according to embodiments. FIGS. 12-0 to 12-3 show transmissions like those of FIG. 6, and such like items are referred to by the same reference characters but with the leading digits being “12” instead of “6”. FIGS. 12-0 to 12-3 differs from FIG. 6 in that there are two Central Units (BLE Central1, BLE Central2).

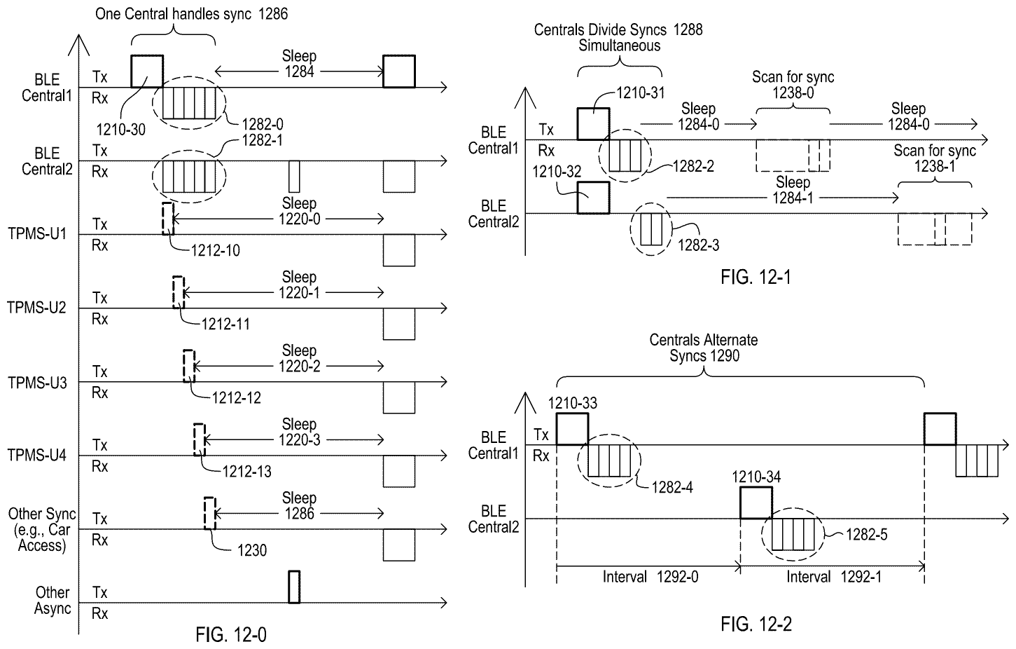

FIG. 12-0 shows operations in which one Central Unit of multiple such units can synchronize responses from multiple TPMS sensor units (and other devices) 1286. BLE Central1 can transmit a synchronization request 1210-30 (e.g., sync transfer packet). In response, TPMS-U1 to -4 can return responses with tire state data (1212-10 to 1212-13) (e.g., PAwR responses). In some embodiments, such responses (1212-10 to -13) can be conditional. BLE Central1 can receive such responses 1282-0. In addition, BLE Central2 can receive the same responses 1282-1. Such an arrangement can provide redundancy and/or more reliability than conventional devices. In some embodiments, a BLE Central2 can also issue its own synchronization request (not shown).

Referring still to FIG. 12-0, in some embodiments, BLE Central1, can have previously executed an authentication operation with TPMS-U1 to -U4 that establishes an encryption scheme, for encrypting tire state data responses 1212-10 to -13. Such derived authentication/encryption data can be provided to BLE Central2 from BLE Central1, to enable BLE Central2 to also decrypt such responses.

FIG. 12-1 shows operations in which synchronized responses are divided between Central Devices. BLE Central1 can issue a request 1210-31 to elicit three responses 1282-2 that include only some of the TPMS sensor units. For example, responses 1282-2 can correspond to two TPMS sensor units (e.g., TPMS-U1, -U2) and another synchronized device (e.g., car access). At about the same time, BLE Central2 can issue a request 1210-32 to elicit responses from remaining TPMS sensor units 1282-3. For example, responses 1282-3 can correspond to TPMS sensor units (e.g., TPMS-U2, -U3). In the embodiment shown, responses for BLE Central1 (1282-0) can be received in different time slots than those from BLE Central2 (1282-3). However, in alternate embodiments, such responses for different BLE Centrals can occupy a same time slot. Further, while FIG. 12-1 shows BLE Central requests 1210-31/1210-32 being issued as the same time, alternate embodiments can include BLE Central requests 1210-31/1210-32 being issued at different times.

FIG. 12-2 shows operations in which different BLE centrals can issue requests over alternating intervals. In a first interval 1292-0 (e.g., advertising interval), BLE Central1 can issue a request 1210-33 to elicit responses 1282-4 from TPMS sensor units. In a next interval 1292-1, BLE Central2 can issue a request 1210-34 to elicit responses 1282-5 from the same TPMS sensor Units.

In some embodiments, TPMS sensor units can be assigned to different Central Units based on a system's operating mode or condition. As but a few of many possible examples, Central Units can synchronize with TPMS sensor units according to signal strength, physical proximity, Central Unit bandwidth, vehicle mode of operation, or tire state. According to embodiments, TPMS sensor unit assignments can dynamically switch change as modes or conditions change.

In this way, systems can include multiple Central Units that can synchronize to a same set of TPMS sensor units. In some configurations, different Central Units can receive tire state data from all TPMS sensor units. In other configurations, TPMS sensor units can be assigned to different Central Units.

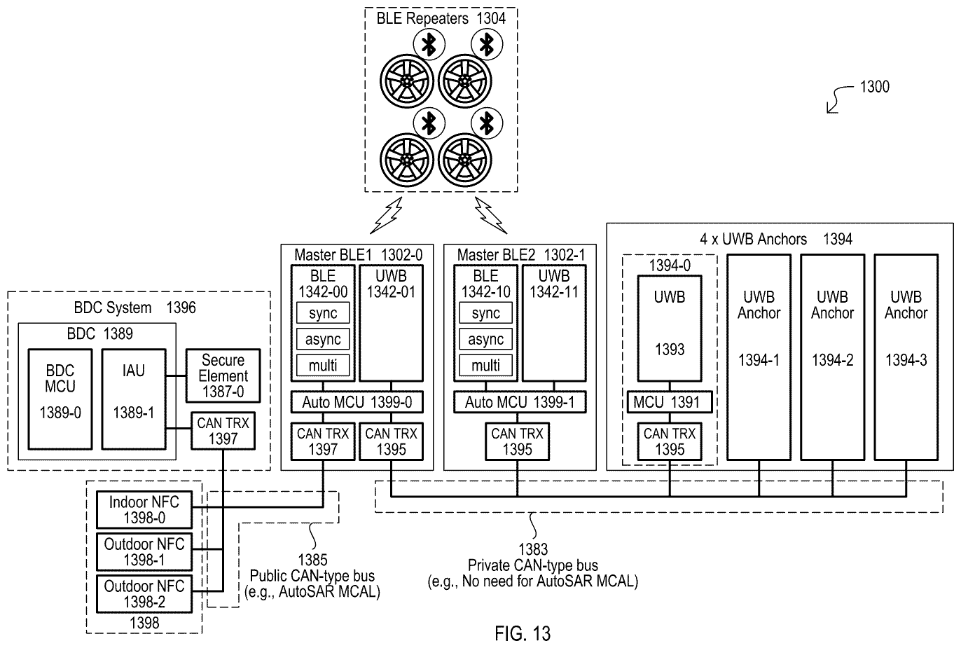

FIG. 13 is a block diagram of a vehicle system 1300 according to an embodiment. A system 1300 can include a first Central Unit (Master BLE1) 1302-0, a second Central Unit (Master BLE2) 1302-1, BLE Repeaters 1304 (which can include TPMS sensor units), ultra-wide band (UWB) anchors 1394, a body domain control (BDC) system 1396, and near field communication (NFC) systems 1398. Master BLE1 1302-0, Master BLE2 1302-1, and UWB anchors 1394 can be in communication with one another over a private CAN bus 1383. Master BLE1 1302-0, BDC system 1396, and NFC systems 1398 can be in communication with one another over a public CAN bus 1385.

Master BLE1 1302-0 can include BLE circuits 1342-00, UWB circuits 1342-01, MCU 1399-0, a first CAN IF 1397 and a second CAN IF 1395. BLE circuits 1342-00 can provide Central Unit operations as described herein, and equivalents, including but not limited to async operations (async), in which BLE circuits 1342-00 can scan for connectable ADVs and synchronous operations, in which BLE circuits 1342 can establish PAwR trains with one or more BLE repeaters 1304. UWB circuits 1342-01 can provide wireless operations for a vehicle system in UWB frequencies (e.g., keyless entry, keyless start, driver/passenger location or occupancy). In some embodiments, UWB frequencies can include, but are not limited to, a range from about 3.1 to 10.6 GHz. MCU 1399-0 can control BLE and UWB circuits 1342-00/01.

Master BLE2 1302-1 can have like components to those of Master BLE1 1302-1, including BLE circuits 1342-10, UWB circuits 1342-11, MCU 1399-1, and a CAN IF 1395. Master BLE2 1302-1 can provide the same operations as first Master BLE1 1302-1.

In some embodiments, Master BLE1 and Master BLE2 (1302-0/1) can operate together to provide multiple Central Unit operations as described herein or equivalents. Such operations can include Master BLEs (1302-0/1) sharing data with one another over CAN bus 1383, including but not limited to, sync info establishing synchronization with BLE repeaters 1304, received tire state data, or authentication/encryption data for decrypting responses from repeaters 1304.

UWB anchors 1394 can include a number of UWB hubs 1394-0 to 1394-3, each of which can include UWB wireless circuits 1393, an MCU 1391 and CAN IF 1395. UWB wireless circuits 1393 can provide UWB operations as described herein. MCU 1391 can control operations of UWB wireless circuits 1393 in response to commands received at CAN IF 1395, and provide received data via the same.

BDC system 1396 can include BDC circuits 1389, a secure element 1387-0 and a CAN IF 1397. BDC circuits 1389 can include a BDC MCU 1389-0 and identity authorization unit (IAU) 1389-1. BDC MCU 1389-0 can control various vehicle functions, including but not limited to vehicle power management, seat features, window/sun roof features, environment control features, lighting features, wiper-washer features). IAU 1389-1 can authorize a user to a vehicle system. Secure element 1387-0 can store secure elements for authorizing users and any other suitable security related operations. In some embodiments, Master BLE1 or BLE2 (1302-0/1) can have access to secure element 1387-0 to enable secure operations as described herein or equivalents (e.g., establishing authentication and establishing schemes with BLE repeaters 1304, key less entry functions with BLE repeaters 1304). CAN IF 1397 can enable communications over CAN bus 1385. NFC systems 1398 can include both indoor NFC circuits 1398-0 and outdoor NFC circuits 1398-1/2.

A public CAN bus 1385 can support/transport communications compatible with one or more existing standards, including but not limited to the Automotive open System Architecture Microcontroller Abstraction Layer (AutoSAR). In contrast, a private CAN bus 1383 may not have such a compatibility.

In this way, a vehicle system can include multiple BLE Central Units in communication with one another over one or more buses, any or all of which can be in communication with BLE repeater devices, including TPMS sensor units. TPMS sensor unit operations can be shared and/or divided among such BLE Central Units.

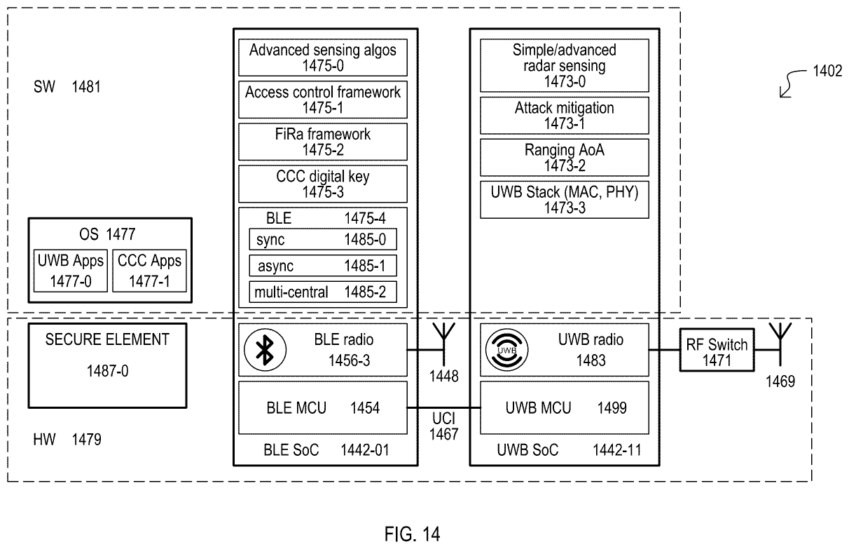

FIG. 14 is a block diagram of a Central Node 1402 and operations according to an embodiment. A Central Node 1402 can include BLE circuits 1442-01 and UWB circuits 1442-11. In the embodiment shown, BLE circuits 1442-01 and UWB circuits 1442-11 can be a system-on-chip type IC devices (SoCs). Operations of a Central Node 1402 can be conceptualized as including software items/operations 1481 and hardware items/operations 1479. Software 1481 can include an operating system (OS) 1477 that can enable first applications 1477-0 and second applications 1477-1. In some embodiments, OS 1477 can include a Javacard OS, first applications 1477-0 can be compatible with a Fine Ranging (FiRa) consortium standard, and second operations 1477-1 can be compatible with a Car Connectivity Consortium (CCC) standard.

BLE circuits 1442-01 operations can include advanced sensing algorithms 1475-0, an access control framework 1475-1, a FiRa framework 1475-2, CCC digital key 1475-3, and BLE operations 1475-4. Advanced sensing algorithms 1475-0 can include using BLE signals for applications including but not limited to locating and range finding, and can include machine learning systems. Access control framework 1475-1 can include basic functions for enabling vehicle access functions using BLE signals (alone and/or in conjunction with other wireless systems). FiRa framework 1475-2 can support FiRa functions and/or applications. CCC digital key 1475-3 can execute digital key operations compatible with a CCC or other standard.

BLE operations 1475-3 can include BLE Central Unit operations as described herein and equivalents, including but not limited to synchronous operations 1485-0, async operations 1485-1 and operations involving multiple Central Units 1485-2. It is understood such operations can integrate digital key functions with TPMS functions, including but not limited to dedicating scanning time (e.g., bandwidth) for sensing BT/BLE based digital key devices while also receiving TPMS sensor unit data and/or synchronizing digital key responses to Central Unit requests (e.g., PAwR). Further, digital key functions can be duplicated and/or moved between multiple Central Units.

LE circuits 1442-01 can include BLE radio circuits 1456-3 and BLE MCU 1454. BLE radio circuits 1456-3 can be connected to a BLE compatible antenna system 1448. BLE MCU 1454 can take the form of any of those described herein, and include memory and processing circuits that provide the SW operations described. BLE circuits 1442-01 can have access to a system SE 1487-0 for security related operations including but not limited to digital key and TPMS sensor unit authentication/encryption.

UWB circuit 1442-01 operations can include simple and advanced radar sensing 1473-0, attack mitigation 1473-1, ranging (e.g., angle of arrival, AoA) 1473-2, and UWB stack 1473-3. UWB circuit 1442-01 hardware can include UWB radio circuits 1483 and a UWB MCU 1499. UWB radio circuits 1483 can be connected to an antenna system 1469 through an RF switch.

While operations for a Central Unit 1402 can take various forms, particular operations will now be described. In an embodiment, a Central Unit 1402 can manage digital key and other BLE devices, while providing sufficient time to scan for (async) TPMS sensor unit ADVs. As but one of many possible examples, while digital key devices (e.g., phones, key fobs) are relatively far away, a Central Unit 1402 can issue ADVs indicating support for digital key operations. A Central Unit could issue such an ADV about every 500 ms that lasts for about 1 ms. This consumes very little of overall airtime (e.g., about 0.5%), enabling plenty of bandwidth for TPMS sensor unit ADVs, which may be transmitting at a slower rate as a vehicle may be stationary.

Even when digital key (and other devices) are connected, a Central Unit 1402 can have a large amount of airtime to service TPMS functions. As but one example, if Central Unit 1402 was servicing eight BLE connections (e.g., digital keys across phones and key fobs), and each connection took about 400 μs every 30 ms, such BLE devices would use only about ˜10% of airtime bandwidth. This could leave a Central Unit with about 90% of its bandwidth available to scan for TPMS sensor unit ADVs and/or initiate synchronous operations (e.g., PAwR).

In this way, a Central Unit can provide BLE and UWB operations, including BLE digital key operations while, at the same time, having sufficient airtime for detecting TPMS sensor unit ADVs.

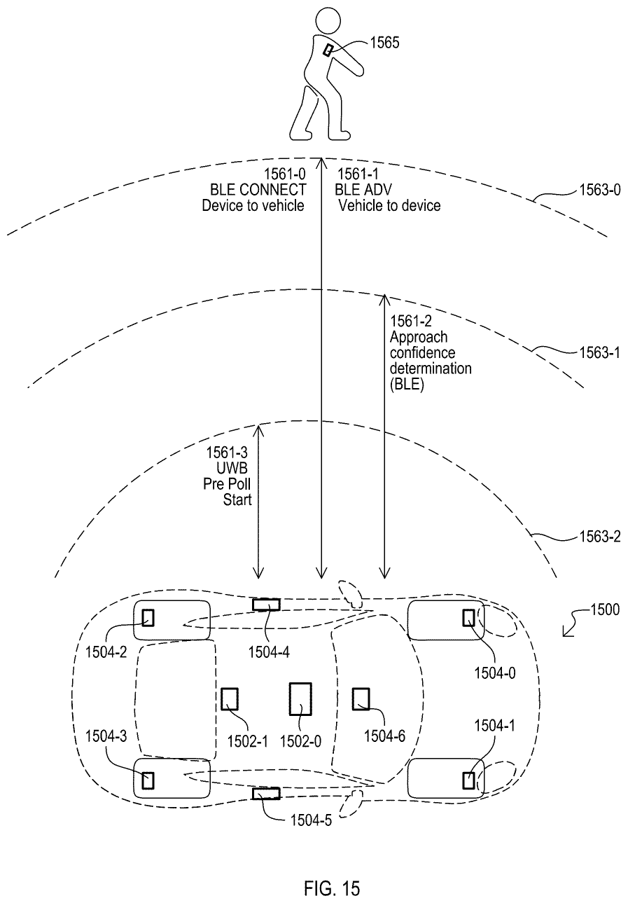

FIG. 15 is a diagram showing vehicle system operations according to another embodiment. FIG. 15 shows a vehicle system 1500 that includes Central Units 1502-0, 1502-1, TPMS sensor units 1504-0 to 1504-3, other units 1504-4 to 1504-6. Central Units 1502-0/1 can include BLE circuits as described herein or equivalents. One or both of Central Units 1502-0/1 may also include UWB circuits. TPMS sensor units (1504-0 to -3) can take the form of any of those described herein or equivalents. Other units (1504-4 to -6) can include BLE circuits, UWB circuits or both. In one embodiment, other units 1504-4/5 can be door handle units, while other unit 1504-6 can be an infotainment unit, or the like.

FIG. 15 also shows a user device 1565 having digital key capabilities. According to embodiments, one or both of Central Units 1502-0/1 can transmit ADVs indicating digital key capabilities. At about a first distance 1563-0, user device 1565 can receive ADVs 1561-0 from Central Unit(s) 1504-0/1, and connect to Central Unit(s) 1561-1. Upon connection, Central Unit(s) 1504-0/1 can begin digital key authentication/identification operations. In some embodiments, a first distance 1563-0 can be about 10 meters (m). Between the transmission of ADVs indicating digital capabilities, Central Unit(s) 1502-0//1 can scan for tire state data ADVs from TPMS sensor units (1504-0 to -3) and/or establish/re-establish PAwR with TPMS sensor units (1504-0 to -3).

As a user approaches, at about a second distance 1563-1, Central Unit(s) 1504-0/1 can make a confidence determination regarding a digital key 1561. Such a determination can be used (by a Central Unit or other system) to enable access to a vehicle system 1500. In some embodiments, a second distance 1563-1 can be about 6 meters (m). Between such communications, Central Unit(s) 1502-0//1 can continue to scan for ADVs from TPMS sensor units (1504-0 to -3) and/or execute PAwR operations with TPMS sensor units (1504-0 to -3).

At about a third distance 1561-2, UWB communications can begin with pre-poll UWB packets. Such an operation can be part of a same digital key authentication process started with BLE communications and/or can be duplicative of such a process. In some embodiments, a third distance 1561-2 can be about 3 m. Upon successful identification/authentication of a digital key, Central Unit(s) 1504-0/1 can continue BLE operations that include any or all of, receiving ADVs from digital key(s), receiving ADVs from TPMS sensor unit(s) (1504-0 to -3), or synchronizing responses of TPMS sensor unit(s) (1504-0 to -3) and/or digital key(s) using PAwR.

In this way, one or more Central Units of a vehicle system can initiate digital key operations using BLE, while at the same time serving as a TPMS.

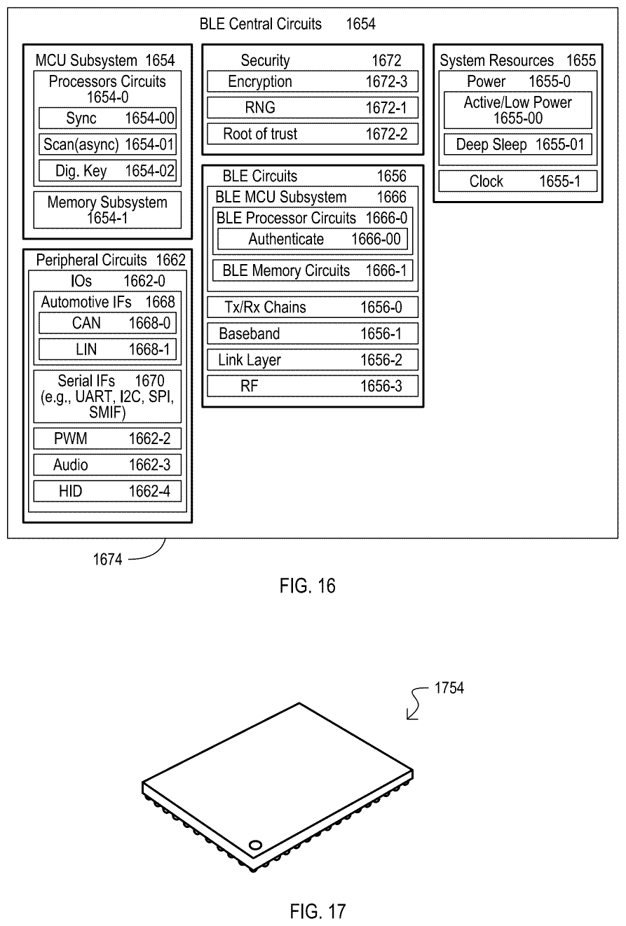

While embodiments can include TPMS systems, TPMS sensor units, Central Units, and systems with multiple Central Units, embodiments can also include BLE circuits for Central Units. FIG. 16 is a diagram of BLE central circuits 1654 that can be included in a Central Unit according to an embodiment. BLE central circuits 1654 can include items like those of FIG. 10, and such like items are referred to by the same reference character but with the leading digits being “16” instead of “10”.

BLE central circuits 1654 can include MCU subsystem 1654, BLE circuits 1656, peripheral circuits 1662, security circuits 1672, and system resources 1655. MCU subsystem 1654 can include processor circuits 1654-0 and memory circuits 1654-1. Processor circuits 1654-0 can execute BLE Central Unit operations as described herein or equivalents. Such operations can include, but are not limited to establishing a synchronous connection to TPMS sensor unit 1654-00, scanning for TPMS sensor unit ADVs 1654-01, and digital key operations 1654-02. Memory circuits 1654-1 can store code executed by processor circuits 1654-0 to provide the various operations noted herein.

BLE circuits 1656 include a BLE MCU subsystem 1666, Tx/Rx chains 1656-0, baseband circuits 1656-1, link layer operations 1656-2, and RF circuits 1656-3. BLE MCU subsystem 1666 can include BLE processor circuits 1666-0 and BLE memory circuits 1666-1. BLE processor circuits 1666-0 can execute BLE compatible authentication operations 1666-00 to validate TPMS sensor units. In addition, such operations can enable BLE processor circuits 1666-0 to decrypt TPMS sensor unit data received in encrypted form.

Peripheral circuits 1662 can include 10 circuits 1662-0 with automotive IFs 1668 and serial IFs 1670. Peripheral circuits 1662 can include PWM circuits 1662-2, audio processing circuits 1662-3, and human interface device (HID) circuits 1662-4.

Security circuits 1672 can include encryption circuits 1672-3 for performing and/or accelerating encryption and decryption operations, as well as RNG generator 1672-1, and a root of trust 1672-2.

In some embodiments, MCU subsystem 1654, BLE circuits 1656, peripheral circuits 1662 and security circuits 1672 can be part of a same integrated circuit substrate or package 1674.

In this way, BLE sensor circuits of a Central Unit can scan for TPMS sensor unit ADVs and/or synchronize TPMS sensor unit reporting operations, while at the same executing digital key operations.

In some embodiments, BLE central circuits can be advantageously compact single integrated circuits (ICs). FIG. 17 shows a packaged IC device 1754 that can operate as BLE central circuits. In some embodiments, IC device 1754 can include circuits like those shown in FIG. 16 or equivalents.

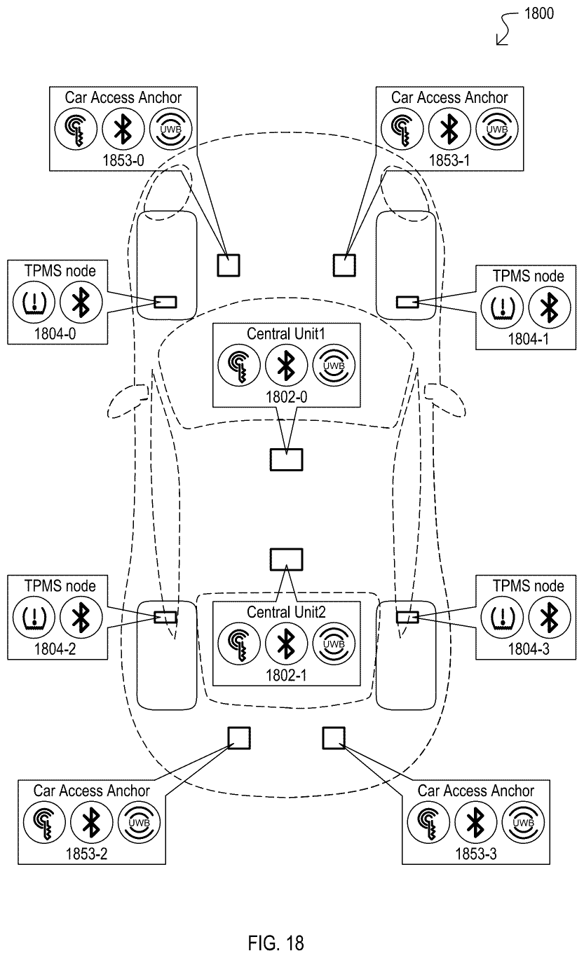

FIG. 18 is a top view of a vehicle system 1800 according to another embodiment. A vehicle system 1800 can include a first Central Unit 1802-0, a second Central Unit 1802-1, TPMS sensor units 1804-0 to 1804-3, and car access anchors 1853-0 to 1853-3. Central Units 1802-0/1 can take the form of any of those described herein or equivalents. Each Central Unit 1802-0/1 can include BLE circuits, UWB circuits, and be capable of performing digital key operations, including those based on BLE, UWB or combinations thereof. At the same time, using BLE circuits, Central Units 1802-0 or 1802-1 can receive tire state data from TPMS sensor units (1804-0 to -3). Such tire state data can be received as connectable ADVs or PAwR responses.

TPMS sensor units (1804-0 to -3) can include BLE circuits in the form of any of those described herein or equivalents. Accordingly, TPMS sensor units (1804-0 to -3) can transition between different modes, including any of storage, park, async, synchronous, or alert. Further, a manner by which tire state can be transmitted can include asynchronous, connectable ADVs as well as synchronous PAwR responses. Further, a rate at which such tire state data is transmitted can vary according to mode (e.g., driving versus tire filling versus alert). In some embodiments, TPMS sensor units (1804-0 to -3) can provide tire state data about every 60 s when a vehicle is being driven.

Car access anchors (1853-0 to -3) can include BLE circuits, UWB circuits, and be capable of performing digital key operations. In some embodiments, car access anchors (1853-0 to -3) can have TPMS monitoring capabilities of Central Units as described herein. Consequently, TPMS monitoring capabilities can be duplicated and/or shared with Central Units, including dynamically.

In this way, a vehicle system can include Central Units with BLE circuits and UWB circuits that can execute digital key functions, while at the same time receiving tire state data from TPMS sensor unit. Car access anchor units with BLE circuits and UWB circuits may also execute digital key operations.

FIGS. 19-0 and 19-1 are timing diagrams showing operations of a Central Unit according to embodiments. A Central Unit can be capable of servicing various BLE peripheral devices (e.g., phones, key fobs), while at the same time providing large amounts of air time to also service TPMS sensor units.

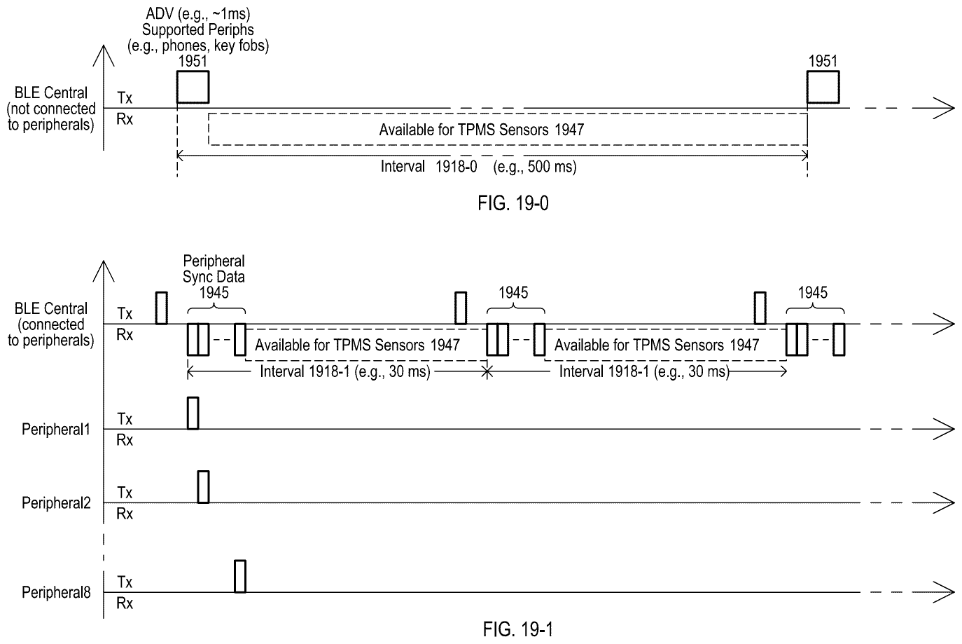

FIG. 19-0 shows operations of a Central Unit while connections have not been made to peripherals. Once during an interval (e.g., advertising interval) 1918-0, a Central Unit may transmit an ADV 1951 indicating the types of peripherals that are supported. The amount of time used by ADV 1951 can be relatively small (e.g., ˜1 ms) as compared to an interval (˜500 ms). This can provide a vast majority of an interval as available for TPMS Sensors 1947. In an availability time 1947, a Central Unit can listen for TPMS Sensor ADVs with tire state data, which may or may not be connectable ADVs. In the case of connectable TPMS sensor unit ADVs, a Central Unit can attempt to synchronization (e.g., PAwR) as described herein or an equivalent.

FIG. 19-1 shows operations of a Central Unit after synchronized connections have been made to eight peripherals. Once per interval 1918-1, a Central Unit can receive synchronized peripheral data 1945. As noted for embodiments herein, while FIG. 19-1 shows peripheral data 1945 as being received in consecutive time slots, alternate embodiments can have responses from peripherals being received at various other time slots distributed throughout an interval 1918-1. The amount of time used by peripheral sync data 1945 can be relatively small (e.g., ˜400 us per peripheral) as compared to an overall interval (˜30 ms). This can result in the large majority of the interval 1918-1 being available for TPMS Sensors operations 1947. As in the case of FIG. 19-0, during availability time 1947, a Central Unit can listen for TPMS sensor unit ADVs with tire state data and/or attempt synchronization with TPMS sensor units.

In this way, while a Central Unit advertises supported peripherals, and after such peripherals are connected, a large amount of remaining air time remains available for TPMS operations.

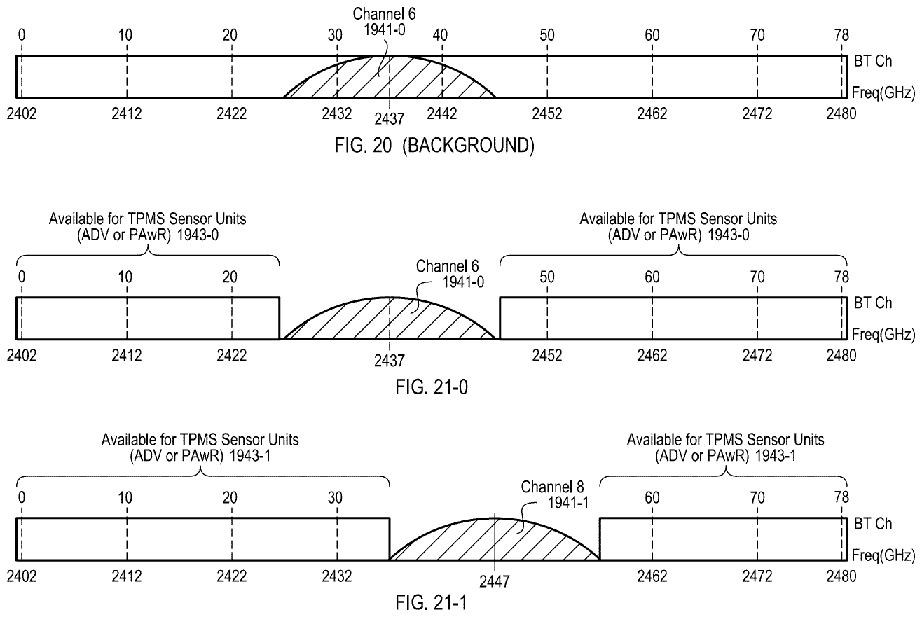

FIG. 20 is a diagram showing conventional channel usage of a BT device. FIG. 20 shows BT channels and corresponding frequencies. A BT device, such as a BLE TPMS Sensor Device can frequency hop between channels (BLE can have larger 2 GHz sized channels). Devices operating according to other standards (e.g., IEEE 802.11 wireless device) can operate on channels that can overlap BT channels. FIG. 20 shows IEEE 802.11b/g channel 6 (1941-0), having a center frequency of 2437 GHz, superimposed on BT channels. This shows how other wireless devices can present sources of interference for TPMS sensor units.

FIGS. 21-0 and 21-1 show TPMS sensor unit channel usage according to an embodiment. Operations of a TPMS sensor unit can be configured to avoid a possibly interfering channel. Thus, frequencies used by TPMS sensor units can be restricted to available frequencies 1943-0 that do not include potentially interfering channels. In some embodiments, a Central Unit can direct a TPMS sensor unit to available frequencies 1943-0. In some embodiments, PAwR responses can be transmitted on available frequencies 1943-0. FIG. 21-1 shows how available frequencies 1943-1 for a TPMS sensor unit can dynamically change based on an interfering channel. In the example shown, the interfering channel 1941-1 can be IEEE 802.11b/g channel 8 (1941-1), having a center frequency of 2447.

In this way, TPMS sensor units can restrict channels on which tire sensor data is transmitted to avoid potentially interfering transmissions on frequencies that overlap BT channels.

In some embodiments, synchronous responses from TPMS sensor units can be transmitted on secondary BLE advertising channels, avoiding primary advertising channels 37, 38 and 39, which can be busy. This can advantageously reduce the possibility of interference.

Synchronization of TPMS sensor unit responses can also reduce interference as TPMS sensor units will not transmit responses at the same time.

Embodiments can include methods, devices and systems where, by operation of at least one TPMS sensor configured for mounting in a tire, operating in an async mode that includes wirelessly transmitting TPMS data ADVs. In response to receiving synchronous information ADV from at least one TPMS central device, switching to a synchronous mode. A synchronous mode can include ceasing transmission of the TPMS data ADVs, entering a low power state in which the TPMS sensor does not wirelessly transmit or receive, prior to a time slot in a repeating advertising interval, leaving the lower power state, and in response to a request message from the at least one TPMS central device, selectively transmitting a TPMS response in the time slot and then re-entering the low power state. TPMS data ADVs and a TPMS response can include tire state data and be compatible with at least one BT standard.

Embodiments can include methods, devices and systems having IO circuits configured to receive tire state data from at least one sensor; first wireless circuits configured to wirelessly transmit and receive data units compatible with at least one wireless standard; and controller circuits. Controller circuits can be configured to, in conjunction with the first wireless circuits, in an async mode, periodically transmit TPMS ADVs, in a low power state, cease wireless transmissions, and in a synchronous mode, in response to a request message from at least one TPMS central device, selectively transmit a TPMS response in a time slot within a repeating advertising interval, then transition to the low power state. Controller circuits can also transition from the async mode to the synchronous mode in response to receiving a synchronous information ADV from the at least one TPMS central device. TPMS data ADVs and a TPMS response can include tire state data and can be compatible with at least one BT standard.

Embodiments can include methods, devices and systems having at least one TPMS sensor configured to, in an async mode, periodically transmit TPMS data ADVs, in a low power state, and cease wireless transmissions. A TPMS sensor can also be configured to, in a synchronous mode, in response to a request message from at least one TPMS central device, selectively transmit a TPMS response in a time slot within a repeating advertising interval, then transition to the low power state. A TPMS sensor may also transition from the async mode to the synchronous mode in response to receiving a synchronous information ADV from the at least one TPMS central device. A system can also include an antenna system coupled to the circuits. TPMS data ADVs and a TPMS response can include tire state data and be compatible with at least one Bluetooth standard.

Methods, devices and systems according to embodiments can include transmitting a TPMS response if tire state data has changed by a predetermined amount from tire state data transmitted in a previous TPMS response, and not transmitting the TPMS response if the tire state data transmitted in the previous TPMS response has not changed by the predetermined amount.

Methods, devices and systems according to embodiments can include an async mode that periodically transmits TPMS data ADVs separated by a time duration of d0. An advertising interval for a synchronous mode can have a duration d1, where d0>d1.

Methods, devices and systems according to embodiments can include, in response to receiving fast mode message from the at least one TPMS central device, periodically transmitting a TPMS response at a faster rate than the async mode and synchronous mode.

Methods, devices and systems according to embodiments can include prior to receiving the synchronous information ADV, executing an authentication operation with the at least one TPMS central device that includes establishing at least one encryption key. A TPMS response can include data encrypted with the at least one encryption key.

Methods, devices and systems according to embodiments can include, by operation of a plurality of the TPMS sensors, starting all TPMS sensors in the async mode in which each TPMS sensor transmits its TPMS data ADV independently of a timing of any other TPMS sensor, and in response each TPMS sensor receiving the synchronous information ADV, each TPMS sensor switching to the synchronous mode in which each TPMS sensor selectively transmits its TPMS response in a different time slot than the other TPMS sensors.

Methods, devices and systems according to embodiments can include, prior to operating in the async mode, being in an inactive mode in which the at least one TPMS monitors for low frequency transmissions and BT transmission and reception are disabled. Subsequently, operations can switch from an inactive mode to the async mode.

Methods, devices and systems according to embodiments can include entering the inactive mode upon the at least one TPMS sensor powering-up; and transitioning from the inactive mode to the async mode in response to the TPMS sensor detecting a predetermined acceleration or increase in tire pressure.

Methods, devices and systems according to embodiments can include transitioning from the synchronous mode to the async mode in response to failing to receive a request message from the at least one TPMS central device.

Methods, devices and systems according to embodiments can include, by operation of the at least one TPMS central device, scanning for the TPMS data ADVs over a scan time period in the repeating advertising interval, after transmitting the synchronous information ADV, ceasing scanning for the TPMS data ADVs and scanning for the TPMS response during the time slot. A duration of the scan time period is greater than a duration of the time slot.

Methods, devices and systems according to embodiments can include controller circuits configured to, in conjunction with the first wireless circuits, in the synchronous mode, transmit the TPMS response if tire state data has changed by a predetermined amount from tire state data transmitted in a previous TPMS response, and not transmit the TPMS response if the tire state data transmitted in the previous TPMS response has not changed by the predetermined amount.

Methods, devices and systems according to embodiments can include controller circuits are configured to execute an authentication operation with the at least one TPMS central device that establishes at least one encryption key; and a TPMS response can include data encrypted with the at least one encryption key.

Methods, devices and systems according to embodiments can include first wireless circuits configured to transmit over a first frequency range and second wireless circuits configured to transmit and receive over a second frequency range lower, and non-overlapping with the first frequency range. Controller circuits can be configured to, in an inactive mode, monitor for lower frequency transmissions with the second wireless circuits while the first wireless circuits are inactive.

Methods, devices and systems according to embodiments can include the IO circuits configured to receive accelerometer data. Controller circuits can be configured to transition from the inactive mode to the async mode in response to accelerometer data or tire pressure data.

Methods, devices and systems according to embodiments can include controller circuits configured to transition from the synchronous mode to the async mode in response to failing to receive a request message from the at least one TPMS central device.

Methods, devices and systems according to embodiments can include a TPMS sensor is configured to, in a synchronous mode, transmit the TPMS response if tire state data has changed by a predetermined amount from tire state data transmitted in a previous TPMS response, and not transmit the TPMS response if the tire state data has not changed by the predetermined amount as compared to tire state data of the previous TPMS response.

Methods, devices and systems according to embodiments can include a plurality of TPMS sensors, each configured to, in the synchronous mode, transmit a TPMS response in a different time slot within an advertising interval, and enter a low power state between transmitting its TPMS response and prior to a next expected request message.

Methods, devices and systems according to embodiments can include a TPMS central device configured to scan for TPMS data ADVs, in response to detecting at least one TPMS ADV, transmit a synchronous information ADV, and cease scanning for TPMS data AVs and receive TPMS responses during at least the time slot.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of exemplary embodiments of the invention, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claims require more features than are expressly recited in each claim. Rather, inventive aspects lie in less than all features of a single foregoing disclosed embodiment. Thus, the claims following the detailed description are hereby expressly incorporated into this detailed description, with each claim standing on its own as a separate embodiment of this invention.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

1. A method, comprising:
by operation of at least one tire pressure monitoring system (TPMS) sensor configured for mounting in a tire,
operating in an asynchronous (async) mode that includes wirelessly transmitting TPMS data advertisements (ADVs),
in response to receiving synchronous information ADV from at least one TPMS central device, switching to a synchronous mode that includes
ceasing transmission of the TPMS data ADVs,
entering a low power state in which the TPMS sensor does not wirelessly transmit or receive,
prior to a time slot in a repeating advertising interval,
leaving the lower power state, and
in response to a request message from the at least one TPMS central device, selectively transmitting a TPMS response in the time slot and then re-entering the low power state; wherein
the TPMS data ADVs and TPMS response include tire state data and are compatible with at least one Bluetooth (BT) standard.

2. The method of claim 1, wherein:
selectively transmitting the TPMS response includes
transmitting the TPMS response if tire state data has changed by a predetermined amount from tire state data transmitted in a previous TPMS response, and
not transmitting the TPMS response if the tire state data has not changed by the predetermined amount as compared to the previous TPMS response.

3. The method of claim 1, wherein:
the async mode includes periodically transmitting the TPMS data ADVs separated by a time duration of d0; and
the advertising interval has a duration d1, where d0>d1.

4. The method of claim 1, further including:
in response to receiving fast mode message from the at least one TPMS central device, periodically transmitting a TPMS response at a faster rate than the async mode and synchronous mode.

5. The method of claim 1, further including:
prior to receiving the synchronous information ADV, executing an authentication operation with the at least one TPMS central device that includes establishing at least one encryption key; and
the TPMS response includes data encrypted with the at least one encryption key.

6. The method of claim 1, further including:
by operation of a plurality of the TPMS sensors,
starting all TPMS sensors in the async mode in which each TPMS sensor transmits its TPMS data ADV independently of a timing of any other TPMS sensor, and
in response each TPMS sensor receiving the synchronous information ADV, each TPMS sensor switching to the synchronous mode in which each TPMS sensor selectively transmits its TPMS response in a different time slot than the other TPMS sensors.

7. The method of claim 1, further including:
prior to operating in the async mode, being in an inactive mode in which the at least one TPMS monitors for low frequency transmissions and BT transmission and reception are disabled; and
subsequently switching from the inactive mode to the async mode.

8. The method of claim 7, wherein:
entering the inactive mode upon the at least one TPMS sensor powering-up; and
transitioning from the inactive mode to the async mode in response to the TPMS sensor detecting a predetermined acceleration or increase in tire pressure.

9. The method of claim 1, further including:
transitioning from the synchronous mode to the async mode in response to failing to receive a request message from the at least one TPMS central device.

10. The method of claim 1, further including:
by operation of the at least one TPMS central device,
scanning for the TPMS data ADVs over a scan time period in the repeating advertising interval,
after transmitting the synchronous information ADV,
ceasing scanning for the TPMS data ADVs and scanning for the TPMS response during the time slot; wherein
a duration of the scan time period is greater than a duration of the time slot.

11. A device, comprising:
input-output (IO) circuits configured to receive tire state data from at least one sensor;
first wireless circuits configured to wirelessly transmit and receive data units compatible with at least one wireless standard;
controller circuits configured to, in conjunction with the first wireless circuits,
in an asynchronous (async) mode, periodically transmit tire pressure monitor system (TPMS) data advertisements (ADVs),
in a low power state, cease wireless transmissions, and
in a synchronous mode, in response to a request message from at least one TPMS central device, selectively transmit a TPMS response in a time slot within a repeating advertising interval, then transition to the low power state, and
transition from the async mode to the synchronous mode in response to receiving a synchronous information ADV from the at least one TPMS central device; wherein
the TPMS data ADVs and TPMS response include tire state data and are compatible with at least one Bluetooth standard.

12. The device of claim 11, wherein:
the controller circuits are configured to, in conjunction with the first wireless circuits, in the synchronous mode,
transmit the TPMS response if tire state data has changed by a predetermined amount from tire state data transmitted in a previous TPMS response, and
not transmit the TPMS response if the tire state data has not changed by the predetermined amount as compared to tire state data transmitted in the previous TPMS response.

13. The device of claim 11, wherein:
the controller circuits are further configured to
execute an authentication operation with the at least one TPMS central device that establishes at least one encryption key; and
the TPMS response includes data encrypted with the at least one encryption key.

14. The device of claim 11, further including:
the first wireless circuits are configured to transmit over a first frequency range;
second wireless circuits configured to transmit and receive over a second frequency range lower, and non-overlapping with the first frequency range; and
the controller circuits are configured to, in an inactive mode, monitor for lower frequency transmissions with the second wireless circuits while the first wireless circuits are inactive.

15. The device of claim 14, wherein:
the IO circuits are configured to receive accelerometer data; and
the controller circuits are configured to transition from the inactive mode to the async mode in response to accelerometer data or tire pressure data.

16. The device of claim 11, further including:
the controller circuits are configured to transition from the synchronous mode to the async mode in response to failing to receive a request message from the at least one TPMS central device.

17. A system, comprising:
at least one tire pressure monitoring system (TPMS) sensor configured to
in an asynchronous (async) mode, periodically transmit TPMS data advertisements (ADVs),
in a low power state, cease wireless transmissions, and
in a synchronous mode, in response to a request message from at least one TPMS central device, selectively transmit a TPMS response in a time slot within a repeating advertising interval, then transition to the low power state, and
transition from the async mode to the synchronous mode in response to receiving a synchronous information ADV from the at least one TPMS central device; and
an antenna system coupled to the circuits; wherein
the TPMS data ADVs and TPMS response include tire state data and are compatible with at least one Bluetooth standard.

18. The system of claim 17, wherein:
the TPMS sensor is configured to, in the synchronous mode,
transmit the TPMS response if tire state data has changed by a predetermined amount from tire state data transmitted in a previous TPMS response, and
not transmit the TPMS response if the tire state data has not changed by the predetermined amount as compared to the previous TPMS response.

19. The system of claim 17, further including:
a plurality of TPMS sensors, each configured to, in the synchronous mode,
transmit a TPMS response in a different time slot within the advertising interval, and
enter a low power state between transmitting its TPMS response and prior to a next expected request message.

20. The system of claim 17, further including:
a TPMS central device configured to scan for TPMS data ADVs,
in response to detecting at least one TPMS ADV, transmit the synchronous information ADV, and
cease scanning for TPMS data AVs and receive TPMS responses during at least the time slot.
